(19) United States
(12) Patent Application Publication
(10) Pub. No.: US 2019/0342546 A1
(43) Pub. Date: Nov. 7, 2019

(54) DEVICE AND METHOD FOR CODING VIDEO DATA BASED ON DIFFERENT REFERENCE SETS IN LINEAR MODEL PREDICTION

(71) Applicant: FG Innovation Company Limited, Tuen Mun (HK)

(72) Inventors: PO-HAN LIN, Taipei (TW); YAO-JEN CHANG, Hsinchu (TW); HONG-JHENG JHU, Hsinchu (TW); HUI-YU JIANG, Hsinchu (TW)

(21) Appl. No.: 16/399,949

(22) Filed: Apr. 30, 2019

Related U.S. Application Data
(60) Provisional application No. 62/666,657, filed on May 3, 2018.
(60) Provisional application No. 62/684,301, filed on Jun. 13, 2018.
(60) Provisional application No. 62/776,029, filed on Dec. 6, 2018.
(60) Provisional application No. 62/809,845, filed on Feb. 25, 2019.

(51) Int. Cl. H04N 19/105; H04N 19/132; H04N 19/149; H04N 19/11; H04N 19/46; H04N 19/186; H04N 19/176

(52) U.S. Cl. CPC H04N 19/105; H04N 19/132; H04N 19/149; H04N 19/176; H04N 19/46; H04N 19/186; H04N 19/11

(57) ABSTRACT

A method of decoding a bitstream by an electronic device is provided. A block unit having a prediction mode is determined from an image frame according to the bitstream. The prediction mode is selected from a plurality of linear modes each including at least one model prediction. A reference set of the block unit is selected from a plurality of candidate sets. Each of the candidate sets includes a plurality of candidate locations selected from a plurality of neighboring locations neighboring to the block unit. A plurality of reference samples is determined from the selected candidate locations in the reference set. A linear model is derived for each of the at least one model prediction in the prediction mode based on the reference samples. The block unit is reconstructed based on the at least one linear model.

### CROSS-REFERENCE TO RELATED APPLICATION(S)

The present application claims the benefit of and priority to a provisional U.S. Patent Application Ser. No. 62/666,657 filed on May 3, 2018, entitled “Reference Setting Method for Linear Model Prediction and Block Partition Method”, Attorney Docket No. US73608 (hereinafter referred to as “US73608 application”), a provisional U.S. Patent Application Ser. No. 62/684,301 filed on Jun. 13, 2018, entitled “Motion Vector Derivation and Sub-block Partition for Affine Mode and Multi-line Prediction for Bi-prediction”, Attorney Docket No. US73832 (hereinafter referred to as “US73832 application”), a provisional U.S. Patent Application Ser. No. 62/776,029 filed on Dec. 6, 2018, entitled “Reference Samples for Linear Model in Linear Mode”, Attorney Docket No. US75728 (hereinafter referred to as “US75728 application”), and a provisional U.S. Patent Application Ser. No. 62/809,845 filed on Feb. 25, 2019, entitled “Mode Adjustments for Intra Sub-Partitions and Linear Mode Modification and Signalling”, Attorney Docket No. US76575 (hereinafter referred to as “US76575 application”). The disclosures of the US73608, US73832, US75728 and US76575 applications are hereby incorporated fully by reference into the present application.

### FIELD

The present disclosure generally relates to video coding, and more particularly, to techniques for different reference sets in linear model prediction.

### BACKGROUND

Linear model prediction is a coding tool for video coding. In a conventional video coding method, an encoder and a decoder only use previously reconstructed pixels adjacent to a block unit and in one predefined reference region to generate a linear model for predicting or reconstructing a plurality of chroma pixels of the block unit based on a plurality of luma reconstructed pixels of the block unit.

However, the one predefined reference region and the one linear model may not be adequate to predict all of the block units in the video. The encoder and the decoder may need different reference regions and more linear models for predicting or reconstructing the chroma pixels.

### SUMMARY

The present disclosure is directed to a device and method for coding video data based on multiple-reference lines.

### BRIEF DESCRIPTION OF THE DRAWINGS

Aspects of the exemplary disclosure are best understood from the following detailed description when read with the accompanying figures. Various features are not drawn to scale, dimensions of various features may be arbitrarily increased or reduced for clarity of discussion.

FIG. 1 is a block diagram of an example implementation of a system configured to encode and decode video data according to one or more techniques of the present disclosure.

FIG. 2 is a block diagram of an example implementation of a decoder module of a destination device in the system of FIG. 1.

FIG. 3 illustrates a flowchart in accordance with a first example implementation of a linear model prediction method based on different reference sets.

FIGS. 4A and 4B are schematic illustrations of exemplary implementations of a block unit and a plurality of neighboring locations neighboring with the block unit.

FIG. 5 illustrates a flowchart in accordance with a second example implementation of a linear model prediction method based on different reference sets.

FIG. 6 illustrates a flowchart in accordance with a third example implementation of a linear model prediction method based on different reference sets.

FIG. 7 illustrates a flowchart in accordance with a fourth example implementation of a linear model prediction method based on different reference sets.

FIG. 8 is a block diagram of an example implementation of the encoder module of the source device in the system of FIG. 1.

FIG. 9 illustrates a flowchart in accordance with an example implementation of a mode signaling method for chroma intra prediction.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

For the purpose of consistency and ease of understanding, like features are identified (although, in some examples, not shown) by numerals in the exemplary figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent.

Additionally, for the purposes of explanation and non-limitation, specific details, such as functional entities, techniques, protocols, standard, and the like are set forth for providing an understanding of the described technology. In other examples, detailed description of well-known methods, technologies, system, architectures, and the like are omitted so as not to obscure the description with unnecessary details.

Persons skilled in the art will immediately recognize that any coding function(s) or algorithm(s) described in the present disclosure may be implemented by hardware, software or a combination of software and hardware. Described functions may correspond to modules may be software, hardware, firmware, or any combination thereof. The software implementation may comprise computer executable instructions stored on computer readable medium such as memory or other type of storage devices. For example, one or more microprocessors or general purpose computers with communication processing capability may be programmed with corresponding executable instructions and carry out the described network function(s) or algorithm(s). The microprocessors or general purpose computers may be formed of applications specific integrated circuitry (ASIC), programmable logic arrays, and/or using one or more digital signal processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to random access memory (RAM), read only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-readable instructions.

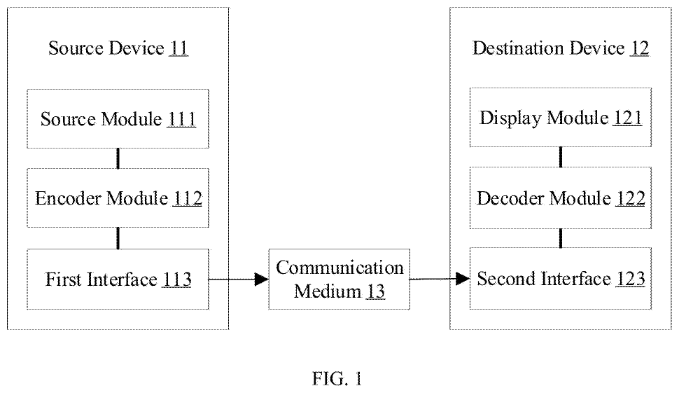

FIG. 1 is a block diagram of an example implementation of a system that may be configured to encode and decode video data according to one or more techniques of the present disclosure. In the implementation, the system includes a source device 11, a destination device 12, and a communication medium 13. In at least one implementation, the source device 11 may include any device configured to encode video data and transmit encoded video data to the communication medium 13. In at least one implementation, the destination device 12 may include any device configured to receive encoded video data via the communication medium 13 and to decode encoded video data.

In at least one implementation, the source device 11 may wiredly and/or wirelessly communicate with the destination device 12 via the communication medium 13. The source device 11 may include a source module 111, an encoder module 112, and a first interface 113. The destination device 12 may include a display module 121, a decoder module 122, and a second interface 123. In at least one implementation, the source device 11 may be a video encoder, and the destination device 12 may be a video decoder.

In at least one implementation, the source device 11 and/or the destination device 12 may be a mobile phone, a tablet, a desktop, a notebook, or other electronic device. FIG. 1 merely illustrates one example of the source device 11 and the destination device 12, and the source device 11 and the destination device 12 in other implementations may include more or less components than illustrated, or have a different configuration of the various components.

In at least one implementation, the source module 111 of the source device 11 may include a video capture device to capture a new video, a video archive storing previously captured video, and/or a video feed interface to receive video from a video content provider. In at least one implementation, the source module 111 of the source device 11 may generate computer graphics-based data as the source video, or a combination of live video, archived video, and computer-generated video. In at least one implementation, the video capturing device may be a charge-coupled device (CCD) image sensor, a complementary metal-oxide-semiconductor (CMOS) image sensor, or a camera.

In at least one implementation, the encoder module 112 and the decoder module 122 may each be implemented as any of a variety of suitable encoder/decoder circuitry, such as one or more microprocessors, a central processing unit (CPU), a graphic processing unit (GPU), a system on chip (SoC), digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. In at least one implementation, each of the encoder module 112 and the decoder module 122 may be included in one or more encoders or decoders, any of which may be integrated as part of a combined encoder/decoder (CODEC) in a respective device.

In at least one implementation, the first interface 113 and the second interface 123 may adopt customized protocols or follow existing standards or de facto standards including, but not limited to, Ethernet, IEEE 802.11 or IEEE 802.15 series, Wireless USB or telecommunication standards including, but not limited to, GSM, CDMA2000, TD-SCDMA, WiMAX, 3GPP-LTE or TD-LTE. In at least one implementation, the first interface 113 and the second interface 123 may each include any device configured to transmit and/or store a compliant video bitstream to the communication medium 13 and to receive the compliant video bitstream from the communication medium 13. In at least one implementation, the first interface 113 and the second interface 123 may include a computer system interface that may enable a compliant video bitstream to be stored on a storage device or to be received from the storage device. For example, the first interface 113 and the second interface 123 may include a chipset supporting Peripheral Component Interconnect (PCI) and Peripheral Component Interconnect Express (PCIe) bus protocols, proprietary bus protocols, Universal Serial Bus (USB) protocols, I2C, or any other logical and physical structure that may be used to interconnect peer devices.

In at least one implementation, the display module 121 may include a display using liquid crystal display (LCD) technology, a plasma display technology, an organic light emitting diode (OLED) display technology, or light emitting polymer display (LPD) technology, although other display technologies may be used in other implementations. In at least one implementation, the display module 121 may include a high definition display or an ultra high definition display.

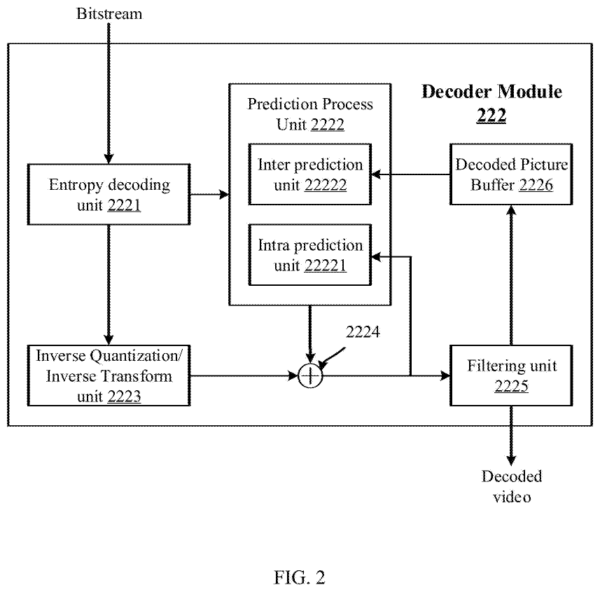

FIG. 2 is a block diagram of a decoder module 222 representing an example implementation of the decoder module 122 of the destination device 12 in the system of FIG. 1. In at least one implementation, the decoder module 222 includes an entropy decoder (e.g., an entropy decoding unit 2221), a prediction processor (e.g., prediction process unit 2222), an inverse quantization/inverse transform processor (e.g., inverse quantization/inverse transform unit 2223), a summer (e.g., a first summer 2224), a filter (e.g., a filtering unit 2225), and a decoded picture buffer (e.g., a decoded picture buffer 2226). In at least one implementation, the prediction process unit 2222 of the decoder module 222 further includes an intra prediction processor (e.g., an intra prediction unit 22221) and an inter prediction processor (e.g., an inter prediction unit 22222). In at least one implementation, the decoder module 222 receives a bitstream, and decodes the bitstream to output a decoded video.

In at least one implementation, the entropy decoding unit 2221 may receive the bitstream including a plurality of syntax elements from the second interface 123 in FIG. 1, and perform a parsing operation on the bitstream to extract syntax elements from the bitstream. As part of performing the parsing operation, the entropy decoding unit 2221 may entropy decode the bitstream to generate quantized transform coefficients, quantization parameters, transform data, motion vectors, intra modes, partition information, and other syntax information. In at least one implementation, the entropy decoding unit 2221 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique to generate the quantized transform coefficients. In at least one implementation, the entropy decoding unit 2221 provides the quantized transform coefficients, the quantization parameters, and the transform data to the inverse quantization/inverse transform unit 2223, and provides the motion vectors, the intra modes, the partition information, and other syntax information to the prediction process unit 2222.

In at least one implementation, the prediction process unit 2222 may receive syntax elements, such as motion vectors, intra modes, partition information, and other syntax information, from the entropy decoding unit 2221. In at least one implementation, the prediction process unit 2222 may receive the syntax elements including the partition information, and then divide image frames according to the partition information. In at least one implementation, each of the image frames may be divided into at least one image block according to the partition information. The at least one image block may include a luminance block for reconstructing a plurality of luminance samples, and at least one chrominance block for reconstructing a plurality of chrominance samples. The luminance block and the at least one chrominance block may be further divided to generate macroblocks, coding tree units (CTUs), coding blocks (CBs), sub-divisions thereof, and/or another equivalent coding unit.

In at least one implementation, during the decoding process, the prediction process unit 2222 receives predicted data including the intra mode or the motion vector for a current image block of a specific one of the image frames. The current image block may be one of the luminance block and the at least one of the chrominance block in the specific image frame.

In at least one implementation, the intra prediction unit 22221 may perform intra-predictive coding of a current block unit relative to one or more neighboring blocks in the same frame as the current block unit based on the syntax elements related to the intra mode to generate a predicted block. In at least one implementation, the intra mode may specify the location of reference samples selected from the neighboring blocks within the current frame.

In at least one implementation, the intra prediction unit 22221 may reconstruct a plurality of chroma components of the current block unit based on the plurality of luma components of the current block unit, when the luma components of the current block are reconstructed by the prediction process unit 2222.

In at least one implementation, the inter prediction unit 22222 may perform inter-predictive coding of the current block unit relative to one or more blocks in one or more reference image block based on the syntax elements related to the motion vector to generate the predicted block. In at least one implementation, the motion vector may indicate a displacement of the current block unit within the current image block relative to a reference block unit within the reference image block. The reference block unit is a block that is determined to closely match the current block unit. In at least one implementation, the inter prediction unit 22222 receives the reference image block stored in the decoded picture buffer 2226 and reconstructs the current block unit based on the received reference image blocks.

In at least one implementation, the inverse quantization/inverse transform unit 2223 may apply inverse quantization and inverse transformation to reconstruct the residual block in the pixel domain. In at least one implementation, the inverse quantization/inverse transform unit 2223 may apply inverse quantization to the residual quantized transform coefficient to generate a residual transform coefficient, and then apply inverse transformation to the residual transform coefficient to generate the residual block in the pixel domain. In at least one implementation, the inverse transformation may be inversely applied the transformation process, such as discrete cosine transform (DCT), discrete sine transform (DST), adaptive multiple transform (AMT), mode-dependent non-separable secondary transform (MDNSST), hypercube-givens transform (HyGT), signal dependent transform, Karhunen-Loéve transform (KLT), wavelet transform, integer transform, sub-band transform or a conceptually similar transform. In at least one implementation, the inverse transformation may convert the residual information from a transform domain, such as a frequency domain, back to the pixel domain. In at least one implementation, the degree of inverse quantization may be modified by adjusting a quantization parameter.

In at least one implementation, the first summer 2224 adds the reconstructed residual block to the predicted block provided from the prediction process unit 2222 to produce a reconstructed block.

In at least one implementation, the filtering unit 2225 may include a deblocking filter, a sample adaptive offset (SAO) filter, a bilateral filter, and/or an adaptive loop filter (ALF) to remove blockiness artifacts from the reconstructed block. Additional filters (in loop or post loop) may also be used in addition to the deblocking filter, the SAO filter, the bilateral filter and the ALF. Such filters are not shown for brevity, but if desired, may filter the output of the first summer 2224. In at least one implementation, the filtering unit 2225 may output the decoded video to the display module 121 or other video receiving unit, after the filtering unit 2225 performs the filtering process for the reconstructed blocks of the specific image frame.

In at least one implementation, the decoded picture buffer 2226 may be a reference picture memory that stores the reference block for use in decoding the bitstream by the prediction process unit 2222, e.g., in inter-coding modes. The decoded picture buffer 2226 may be formed by any of a variety of memory devices, such as dynamic random access memory (DRAM), including synchronous DRAM (SDRAM), magneto-resistive RAM (MRAM), resistive RAM (RRAM), or other types of memory devices. In at least one implementation, the decoded picture buffer 2226 may be on-chip with other components of the decoder module 222, or off-chip relative to those components.

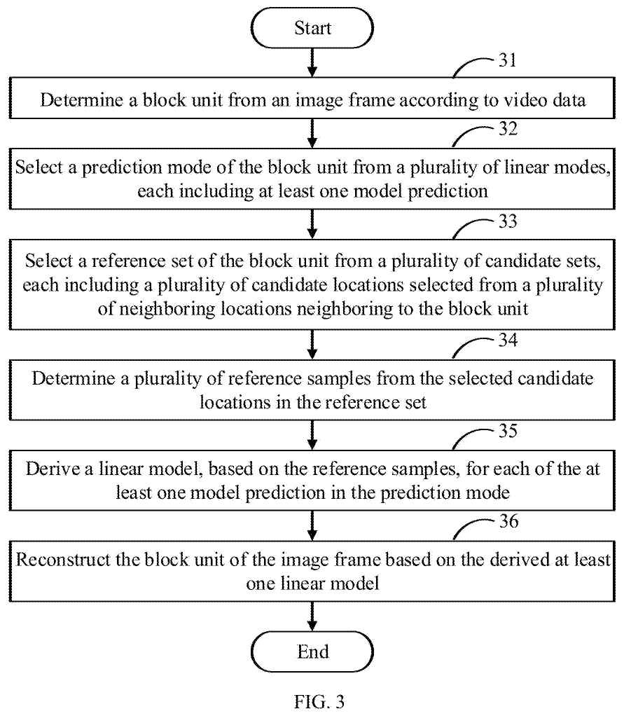

FIG. 3 illustrates a flowchart in accordance with a first example implementation of a linear model prediction method based on different reference sets. The example method is provided by way of example only, as there are a variety of ways to carry out the method. The method described below may be carried out using the configurations illustrated in FIG. 1 and FIG. 2, for example, and various elements of these figures are referenced in explaining the example method. Each block shown in FIG. 3 represents one or more processes, methods, or subroutines, carried out in the example method. Furthermore, the order of blocks is illustrative only and may change. Additional blocks may be added or less blocks may be utilized without departing from this disclosure.

At block 31, the decoder module 222 determines a block unit from an image frame according to video data.

In at least one implementation, the video data may be a bitstream. The destination device 12 may receive the bitstream from an encoder, such as the source device 11, via the second interface 123 of the destination device 12. The second interface 123 provides the bitstream to the decoder module 222. The decoder module 222 determines the image frame based on the bitstream, and divides the image frame to determine the block unit according to a plurality of partition indications in the bitstream. For example, the decoder module 222 may divide the image frames to generate a plurality of coding tree units, and further divide one of the coding tree units to determine the block unit according to the partition indications based on any video coding standard.

In at least one implementation, the entropy decoding unit 2221 may decode the bitstream to determine a plurality of prediction indications for the block unit, and then the decoder module 222 may further reconstruct the block unit based on the prediction indications. In at least one implementation, the prediction indications may include a plurality of flags and a plurality of indices.

At block 32, the intra prediction unit 22221 selects a prediction mode of the block unit from a plurality of linear modes, each including at least one model prediction.

In at least one implementation, the linear modes may include a cross-component linear model (CCLM) prediction mode and a multiple models linear model (MMLM) prediction mode. In at least one implementation, the intra prediction unit 22221 may use a linear model to predict the block unit, when the prediction mode is the CCLM prediction mode. In at least one implementation, the intra prediction unit 22221 may use more than one linear model to predict the block unit, when the prediction mode is the MMLM prediction mode.

At block 33, the intra prediction unit 22221 selects a reference set of the block unit from a plurality of candidate sets, each including a plurality of candidate locations selected from a plurality of neighboring locations neighboring to the block unit.

In at least one implementation, the prediction process unit 2222 determines the block unit from the bitstream, and determines the neighboring locations neighboring to the block unit. In at least one implementation, a first one of the candidate sets may include the neighboring locations located above the block unit and located to a left side of the block unit, a second one of the candidate sets may include the neighboring locations located to the left side of the block unit and located to a left-below side of the block unit, and a third one of the candidate sets may include the neighboring locations located above the block unit and located to a top-right side of the block unit.

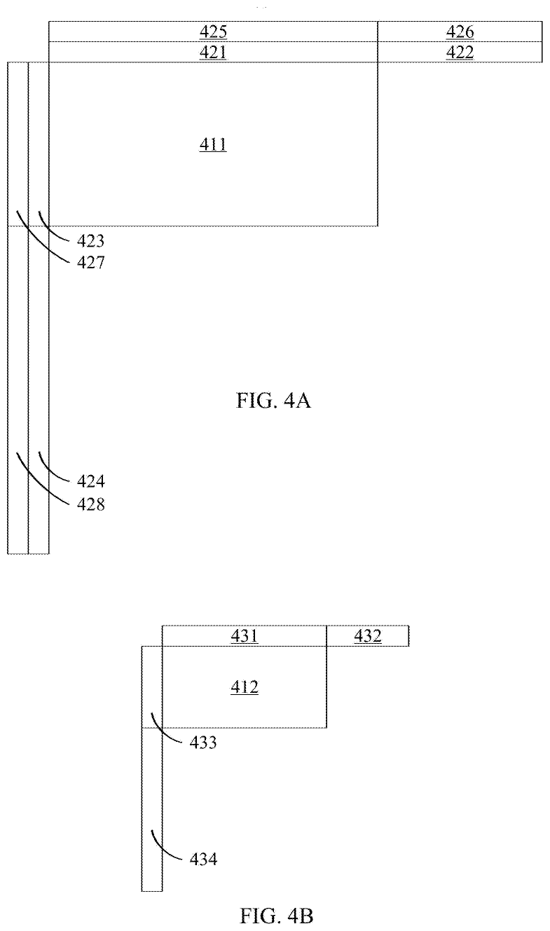

In at least one implementation, the block unit may include a luma block unit and a chroma block unit. FIG. 4A is a schematic illustration of one example implementation of a luma block unit 411 and a plurality of luma neighboring locations 421-428 neighboring with the luma block unit 411. In at least one implementation, each of the candidate sets includes the candidate locations selected from the plurality of luma neighboring locations 421-428. For example, the candidate locations in a first one of the candidate sets may include the first luma neighboring location 421, the third luma neighboring location 423, the fifth luma neighboring location 425, and the seventh luma neighboring location 427. In at least one implementation, the candidate locations in a second one of the candidate sets may include the first luma neighboring location 421, the second luma neighboring location 422, the fifth luma neighboring location 425, and the sixth luma neighboring location 426. In at least one implementation, the candidate locations in a third one of the candidate sets may include the third luma neighboring location 423, the fourth luma neighboring location 424, the seventh luma neighboring location 427, and the eighth luma neighboring location 428. FIG. 4B is a schematic illustration of one example implementation of a chroma block unit 412 and a plurality of chroma neighboring locations 431-434 neighboring with the chroma block unit 412. For example, the candidate locations in the first candidate set may include the first chroma neighboring location 431 and the third chroma neighboring location 433. In at least one implementation, the candidate locations in the second candidate set may include the first chroma neighboring location 431, and the second chroma neighboring location 432. In at least one implementation, the candidate locations in the third candidate set may include the third chroma neighboring location 433 and the fourth chroma neighboring location 434. In at least one implementation, the neighboring locations in the selected candidate set may be a plurality of reference locations for the block unit, when the reference set is selected from the candidate sets. In the implementation, the reference locations may include the luma neighboring locations and the chroma neighboring locations of the selected candidate set. In at least one implementation, the neighboring locations located above the block unit may include the first luma neighboring location 421, the fifth luma neighboring location 425, and the first chroma neighboring location 431. In at least one implementation, the neighboring locations located to the top-right side of the block unit may include the second luma neighboring location 422, the sixth luma neighboring location 426, and the second chroma neighboring location 432. In at least one implementation, the neighboring locations located to the left side of the block unit may include the third luma neighboring location 423, the seventh luma neighboring location 427, and the third chroma neighboring location 433. In at least one implementation, the neighboring locations located to the left-below side of the block unit may include the fourth luma neighboring location 424, the eighth luma neighboring location 428, and the fourth chroma neighboring location 434.

In at least one implementation, the first luma neighboring location 421 may be adjacent to the luma block unit 411 and located above the luma block unit 411. In at least one implementation, the second luma neighboring location 422 may be adjacent to the first luma neighboring location 421 and located to the right side of the first luma neighboring location 421. In at least one implementation, the third luma neighboring location 423 may be adjacent to the luma block unit 411 and located to the left side of the luma block unit 411. In at least one implementation, the fourth luma neighboring location 424 may be adjacent to the third luma neighboring location 423 and located below the third luma neighboring location 423. In at least one implementation, the fifth luma neighboring location 425 may be adjacent to the first luma neighboring location 421 and located above the first luma neighboring location 421. In at least one implementation, the sixth luma neighboring location 426 may be adjacent to the second luma neighboring location 422 and the fifth luma neighboring location 425, located above the second luma neighboring location 422 and located to the right side of the fifth luma neighboring location 425. In at least one implementation, the seventh luma neighboring location 427 may be adjacent to the third luma neighboring location 423 and located to the left side of the third luma neighboring location 423. In at least one implementation, the eighth luma neighboring location 428 may be adjacent to the fourth luma neighboring location 424 and the seventh luma neighboring location 427, located to the left side of the fourth luma neighboring location 424 and located below the seventh luma neighboring location 427. In at least one implementation, the first chroma neighboring location 431 may be adjacent to the chroma block unit 412 and located above the chroma block unit 412. In at least one implementation, the second chroma neighboring location 432 may be adjacent to the first chroma neighboring location 431 and located to the right side of the first chroma neighboring location 431. In at least one implementation, the third chroma neighboring location 433 may be adjacent to the chroma block unit 412 and located to the left side of the chroma block unit 412. In at least one implementation, the fourth chroma neighboring location 434 may be adjacent to the third chroma neighboring location 433 and located below the third chroma neighboring location 433. In at least one implementation, each of a plurality of first location heights of the first, second, fifth, and sixth luma neighboring locations 421-422 and 425-426, and the first and second chroma neighboring locations 431-432 may be equal to a plurality of first location widths of the third, fourth, seventh, and eighth luma neighboring location 423-424 and 427-428, and the third and fourth chroma neighboring locations 433-434. In at least one implementation, each of the first location heights and the first location widths may be equal to one of at least one pixel height and at least one pixel width. In at least one implementation, each of the first location heights and the first location widths may be equal to one of one pixel height and one pixel width. In at least one implementation, the pixel height and the pixel width may be the height and the width of a pixel element. In at least one implementation, a plurality of second location widths of the first, second, fifth, and sixth luma neighboring locations 421-422 and 425-426, and the first and second chroma neighboring locations 431-432, and a plurality of second location heights of the third, fourth, seventh, and eighth luma neighboring location 423-424 and 427-428, and the third and fourth chroma neighboring locations 433-434 are determined based on a block size of the block unit.

At block 34, the intra prediction unit 22221 determines a plurality of reference samples from the selected candidate locations in the reference set.

In at least one implementation, the neighboring locations may be included in a plurality of neighboring blocks. In at least one implementation, the neighboring locations may include a plurality of neighboring samples, when the neighboring blocks having the neighboring locations are reconstructed prior to reconstructing the block unit. In the implementation, the neighboring samples may include a plurality of luma neighboring samples located in the luma neighboring locations and a plurality of chroma neighboring samples located in the chroma neighboring locations. In at least one implementation, there is no neighboring sample in a specific one of the neighboring locations, when the block unit is reconstructed prior to reconstructing a specific one of the neighboring block having the specific neighboring location. In at least one implementation, the block unit may include a plurality of block boundaries. In at least one implementation, there is no neighboring location near a specific one of the block boundaries, when the specific block boundary is identical to a frame boundary of the image frame. Thus, there is no neighboring sample near the specific block boundary.

In at least one implementation, the intra prediction unit 22221 may select the reference samples from the neighboring samples. In the implementation, the reference samples are the neighboring samples located in the reference locations of the reference set. Thus, the reference samples may include a plurality of luma reference samples and a plurality of chroma reference samples. In at least one implementation, the luma reference samples may be the luma neighboring samples located in the luma neighboring locations of the reference set, and the chroma reference samples may be the chroma neighboring samples located in the chroma neighboring locations of the reference set. In at least one implementation, the intra prediction unit 22221 may further down-sample the luma reference samples to determine a plurality of luma down-sampled samples in the reference set.

At block 35, the intra prediction unit 22221 derives a linear model, based on the reference samples, for each of the at least one model prediction in the prediction mode.

In at least one implementation, the intra prediction unit 22221 may derive one linear model for the block unit, when the number of the at least one model prediction is equal to one. In the implementation, the linear model may be shown by the following equation (1):

pred_{C}(i,j)=α·rec_{L}′(i,j)+β (1)

where pred_{C}(i,j) represents one of a plurality of chroma predicted components in the chroma block unit 412, rec_{L}′(i,j) represents one of a plurality of luma down-sampled components in the luma block unit 411, and α and β represent a predicted parameter and a constant parameter derived based on the reference samples. In at least one implementation, the luma down-sampled components is generated by down-sampling a plurality of luma reconstructed components in the luma block unit 411. In at least one implementation, the chroma predicted components may be generated based on the luma reconstructed components according to the linear model, since the luma reconstructed components are reconstructed prior to generating the chroma predicted components.

In at least one implementation, the intra prediction unit 22221 may derive the predicted parameter α and the constant parameter β based on the reference samples in the reference set, when the intra prediction unit 22221 may generate the chroma predicted components of the chroma block unit 412 based on the luma reconstructed components of the luma block unit 411. In at least one implementation, the intra prediction unit 22221 may estimate the predicted parameter α and the constant parameter β based on the chroma reference samples and the luma down-sampled samples via a statistical method. In at least one implementation, the statistical method may be a linear regression analysis. In at least one implementation, the two parameters α and β may be derived by the following equation (2):

$$α = \frac{N \cdot \sum ( L ( n ) \cdot C ( n ) ) - \sum L ( n ) \cdot \sum C ( n )}{N \cdot \sum ( L ( n ) \cdot L ( n ) ) - \sum L ( n ) \cdot \sum L ( n )}$$

$$β = \frac{\sum C ( n ) - α \cdot \sum L ( n )}{N}$$

wherein L(n) represents the luma down-sampled samples, C(n) represents the chroma reference samples, and the value of N may be equal to twice of the minimum of width and height of the current chroma block. In at least one implementation, the intra prediction unit 22221 may estimate the predicted parameter α and the constant parameter β based on a part or all of the chroma reference samples and the luma down-sampled samples via another derivation methods. For example, the predicted parameter α and the constant parameter β may be derived based on two of the luma down-sampled samples and two of the chroma reference samples. In the implementation, the two of the luma down-sampled samples have a first maximum sample value and a first minimum sample value determined from the luma down-sampled samples, and the two of the chroma reference samples are collocated with the two of the luma down-sampled samples.

In at least one implementation, the intra prediction unit 22221 may derive a plurality of linear models for the block unit, when the number of the at least one model prediction is greater than one. For example, the intra prediction unit 22221 may derive two linear models for the block unit, when the number of the at least one model prediction is equal to two. In at least one implementation, the number of the at least one model prediction is set as N. Thus, the reference samples may be separated into N sample groups based on at least one threshold value. In at least one implementation, the at least one threshold value may be derived based on a part of the reference samples. In the implementation, the number N is an integer greater than one, and the number of the at least one threshold value may be equal to N−1.

In at least one implementation, the at least one threshold value may be estimated based on a part or all of the luma reference samples. In at least one implementation, the at least one threshold value may be estimated based on a maximum sample value and a minimum sample value of the luma reference samples. For example, the at least one threshold value may be equal to a first average estimated based on all of the luma down-sampled samples, when the number of the at least one model prediction is equal to two. In one implementation, the at least one threshold value may be equal to a second average estimated based on all of the luma reference samples, when the number of the at least one model prediction is equal to two. In one implementation, the at least one threshold value may be equal to a third average estimated based on the first maximum sample value and the first minimum sample value selected from the luma down-sampled samples, when the number of the at least one model prediction is equal to two. In one implementation, the at least one threshold value may be equal to a fourth average estimated based on a second maximum sample value and a second minimum sample value selected from the luma reference samples, when the number of the at least one model prediction is equal to two. In at least one implementation, the luma down-sampled samples may be divided into the N sample groups based on the at least one threshold value, when the at least one threshold value is derived based on the luma reference samples or the luma down-sampled samples. In the implementation, a specific one of the chroma reference samples may be assigned into a Kth one of the sample groups, when a specific one of the luma down-sampled samples collocated with the specific chroma reference sample is assigned into the Kth sample group. In the implementation, the number K is a positive integer equal to or less than N.

In at least one implementation, the at least one threshold value may be estimated based on a part or all of the chroma reference samples. For example, the at least one threshold value may be equal to a fifth average estimated based on all of the chroma reference samples, when the number of the at least one model prediction is equal to two. In one implementation, the at least one threshold value may be equal to a sixth average estimated based on a third maximum sample value and a third minimum sample value selected from the chroma reference samples, when the number of the at least one model prediction is equal to two. In at least one implementation, the chroma reference samples may be divided into the N sample groups based on the at least one threshold value, when the at least one threshold value is derived based on the chroma reference samples. In the implementation, the specific luma down-sampled sample may be assigned into the Kth the sample group, when the specific chroma reference sample collocated with the specific luma down-sampled sample is assigned into the Kth sample group.

In at least one implementation, the intra prediction unit 22221 may derive a linear model for each of the N sample groups. In at least one implementation, the intra prediction unit 22221 may derive N parameter sets, each including one of N predicted parameters and one of N constant parameters. In at least one implementation, the intra prediction unit 22221 may estimate a Rth one of the parameter sets based on a part or all of the reference samples in a Rth one of the sample groups via a statistical method or the other derivation methods. In the implementation, the number R is a positive integer equal to or less than N.

At block 36, the intra prediction unit 22221 reconstructs the block unit of the image frame based on the derived at least one linear model.

In at least one implementation, the chroma predicted components may be generated based on the luma reconstructed components according to the at least one linear model, since the luma reconstructed components are reconstructed prior to generating the chroma predicted components. In at least one implementation, the intra prediction unit 22221 may directly estimate the chroma predicted components based on the luma down-sampled components according to the at least one linear model, when the number of the at least one linear model is equal to one. In at least one implementation, the intra prediction unit 22221 may first compare a specific one of the luma down-sampled components with the at least one threshold value to check which one of the N sample groups the specific luma down-sampled component belongs to, when the number of the at least one linear model is greater than one. Then, the intra prediction unit 22221 may estimate a specific one of the chroma predicted components collocated with the specific luma down-sampled components according to a Qth one of the at least one linear model, when the specific luma down-sampled components belongs to a Qth one of the sample groups. In the implementation, the number Q is a positive integer equal to or less than N.

In at least one implementation, the chroma block unit 412 may include a plurality of chroma block elements. In the implementation, each of the chroma block elements may be a chroma pixel element. The intra prediction unit 22221 may generate one of the chroma predicted components for each of the block elements. In at least one implementation, the first summer 2224 of the decoder module 222 in the destination device 12 may add the chroma predicted components into a plurality of chroma residual samples determined from the bitstream to reconstruct the chroma block unit of the block unit. In addition, the decoder module 222 may reconstruct all of the other block units in the image frame for reconstructing the image frame and the video.

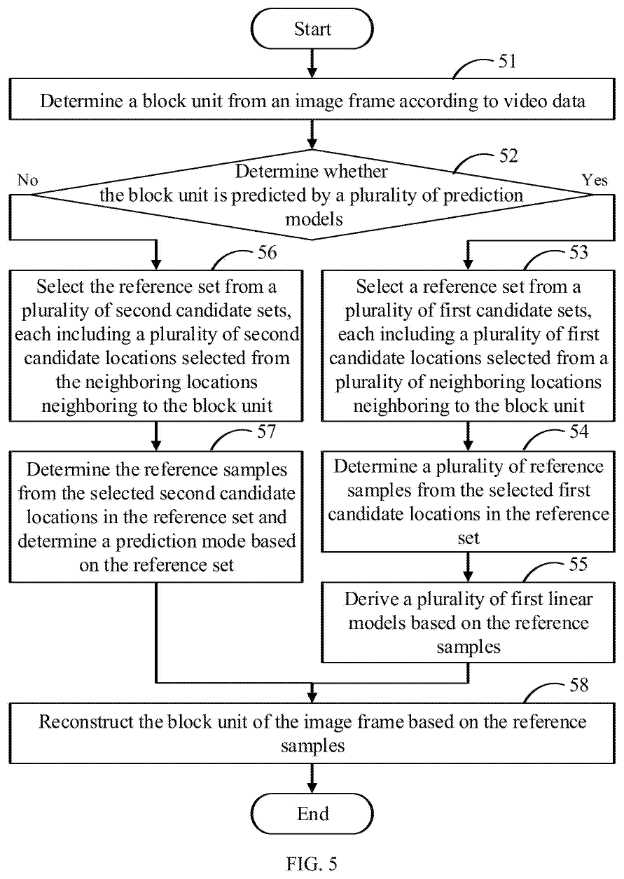

FIG. 5 illustrates a flowchart in accordance with a second example implementation of a mode selection method for intra prediction. The mode selection method is provided by way of example only, as there are a variety of ways to carry out the method. The method described below may be carried out using the configurations illustrated in FIG. 1 and FIG. 2, for example, and various elements of these figures are referenced in explaining the example method. Each block shown in FIG. 5 represents one or more processes, methods, or subroutines, carried out in the example method. Furthermore, the order of blocks is illustrative only and may change. Additional blocks may be added or less blocks may be utilized without departing from this disclosure.

At block 51, the decoder module 222 determines a block unit from an image frame according to video data.

In at least one implementation, the video data may be a bitstream. The destination device 12 may receive the bitstream from an encoder, such as the source device 11, via the second interface 123 of the destination device 12. The second interface 123 provides the bitstream to the decoder module 222. The decoder module 222 determines the image frame based on the bitstream, and divides the image frame to determine the block unit according to a plurality of partition indications in the bitstream. For example, the decoder module 222 may divide the image frames to generate a plurality of coding tree units, and further divide one of the coding tree units to determine the block unit according to the partition indications based on any video coding standard.

In at least one implementation, the entropy decoding unit 2221 may decode the bitstream to determine a plurality of prediction indications for the block unit, and then the decoder module 222 may further reconstruct the block unit based on the prediction indications. In at least one implementation, the prediction indications may include a plurality of flags and a plurality of indices.

At block 52, the intra prediction unit 22221 determines whether the block unit is predicted by a plurality of prediction models. When the block unit is predicted by the plurality of prediction models, the procedure proceeds to block 53. When the block unit is not predicted by the plurality of prediction models, the procedure proceeds to block 56.

In at least one implementation, the block unit is predicted by a multiple models linear model (MMLM) prediction mode, when the block unit is predicted by the plurality of prediction models. In at least one implementation, the block unit is predicted by one of a cross-component linear model (CCLM) prediction mode and a plurality of chroma intra prediction modes, when the block unit is not predicted by the plurality of prediction models.

In at least one implementation, the intra prediction unit 22221 may determine, based on a model flag, whether the block unit is predicted by the plurality of prediction models. When the model flag is equal to a first flag value, the intra prediction unit 22221 may determine that the block unit is predicted by the plurality of prediction models. When the model flag is equal to a second flag value, the intra prediction unit 22221 may determine that the block unit is predicted by one of the CCLM prediction modes and the chroma intra prediction modes. In at least one implementation, the first flag value may be equal to one, and the second flag value may be equal to zero.

At block 53, the intra prediction unit 22221 selects a reference set from a plurality of first candidate sets, each including a plurality of first candidate locations selected from a plurality of neighboring locations neighboring to the block unit.

In at least one implementation, the prediction process unit 2222 determines the block unit from the bitstream, and determines the neighboring locations neighboring with the block unit. In at least one implementation, the block unit may include a luma block unit and a chroma block unit. FIG. 4A is a schematic illustration of one example implementation of the luma block unit 411 and a plurality of luma neighboring locations 421-428 neighboring with the luma block unit 411. In at least one implementation, each of the first candidate sets includes the first candidate locations selected from the plurality of luma neighboring locations 421-428. For example, the first candidate locations in a first one of the first candidate sets may include the first luma neighboring location 421, the third luma neighboring location 423, the fifth luma neighboring location 425, and the seventh luma neighboring location 427. In at least one implementation, the first candidate locations in a second one of the first candidate sets may include the first luma neighboring location 421, the second luma neighboring location 422, the fifth luma neighboring location 425, and the sixth luma neighboring location 426. In at least one implementation, the first candidate locations in a third one of the first candidate sets may include the third luma neighboring location 423, the fourth luma neighboring location 424, the seventh luma neighboring location 427, and the eighth luma neighboring location 428. FIG. 4B is a schematic illustration of one example implementation of the chroma block unit 412 and a plurality of chroma neighboring locations 431-434 neighboring with the chroma block unit 412. For example, the first candidate locations in the first one of the first candidate sets may include the first chroma neighboring location 431 and the third chroma neighboring location 433. In at least one implementation, the first candidate locations in the second one of the first candidate sets may include the first chroma neighboring location 431, and the second chroma neighboring location 432. In at least one implementation, the first candidate locations in the third one of the first candidate sets may include the third chroma neighboring location 433 and the fourth chroma neighboring location 434. In at least one implementation, the neighboring locations of the selected first candidate set may be a plurality of reference locations for the block unit, when the reference set is selected from the first candidate sets. In the implementation, the reference locations may include the luma neighboring locations and the chroma neighboring locations of the selected first candidate set.

At block 54, the intra prediction unit 22221 determines a plurality of reference samples from the selected first candidate locations in the reference set.

In at least one implementation, the neighboring locations may be included in a plurality of neighboring blocks. In at least one implementation, the neighboring locations may include a plurality of neighboring samples, when the neighboring blocks having the neighboring locations are reconstructed prior to reconstructing the block unit. In the implementation, the neighboring samples may include a plurality of luma neighboring samples located in the luma neighboring locations and a plurality of chroma neighboring samples located in the chroma neighboring locations. In at least one implementation, there is no neighboring sample in a specific one of the neighboring locations, when the block unit are reconstructed prior to reconstructing a specific one of the neighboring blocks having the specific neighboring location. In at least one implementation, the block unit may include a plurality of block boundaries. In at least one implementation, there is no neighboring location near a specific one of the block boundaries, when the specific block boundary is identical to a frame boundary of the image frame. Thus, there is no neighboring sample near the specific block boundary.

In at least one implementation, the intra prediction unit 22221 may select the reference samples from the neighboring samples. In the implementation, the reference samples are the neighboring samples located in the reference locations of the reference set. Thus, the reference samples may include a plurality of luma reference samples and a plurality of chroma reference samples. In at least one implementation, the luma reference samples may be the luma neighboring samples located in the luma neighboring locations of the reference set, and the chroma reference samples may be the chroma neighboring samples located in the chroma neighboring locations of the reference set. In at least one implementation, the intra prediction unit 22221 may further down-sample the luma reference samples to determine a plurality of luma down-sampled samples in the reference set.

At block 55, the intra prediction unit 22221 derives a plurality of first linear models, based on the reference samples.

In at least one implementation, the intra prediction unit 22221 may derive the first linear models for the block unit. For example, the intra prediction unit 22221 may derive two linear models for the block unit, when the number of the model predictions is equal to two. Thus, the reference samples may be separated into N sample groups based on at least one threshold value, when the number of the model predictions is set as N. In at least one implementation, the at least one threshold value may be derived based on a part of the reference samples. In at least one implementation, the number N is an integer greater than one, and the number of the at least one threshold value may be equal to N−1.

In at least one implementation, the at least one threshold value may be estimated based on a part or all of the luma reference samples. For example, the at least one threshold value may be equal to a first average estimated based on all of the luma down-sampled samples, when the number of the at least one model prediction is equal to two. In one implementation, the at least one threshold value may be equal to a second average estimated based on all of the luma reference samples, when the number of the at least one model prediction is equal to two. In one implementation, the at least one threshold value may be equal to a third average estimated based on a first maximum sample value and a first minimum sample value selected from the luma down-sampled samples, when the number of the at least one model prediction is equal to two. In one implementation, the at least one threshold value may be equal to a fourth average estimated based on a second maximum sample value and a second minimum sample value selected from the luma reference samples, when the number of the at least one model prediction is equal to two. In at least one implementation, the luma down-sampled samples may be divided into the N sample group based on the at least one threshold value, when the at least one threshold value is derived based on the luma reference samples or the luma down-sampled samples. In the implementation, a specific one of the chroma reference samples may be assigned into a Kth one of the sample groups, when a specific one of the luma down-sampled samples collocated with the specific chroma reference sample is assigned into the Kth sample group. In at least one implementation, the number K is a positive integer equal to or greater than N.

In at least one implementation, the at least one threshold value may be estimated based on a part or all of the chroma reference samples. For example, the at least one threshold value may be equal to a fifth average estimated based on all of the chroma reference samples, when the number of the at least one model prediction is equal to two. In one implementation, the at least one threshold value may be equal to a sixth average estimated based on a third maximum sample value and a fourth minimum sample value selected from the chroma reference samples, when the number of the at least one model prediction is equal to two. In at least one implementation, the chroma reference samples may be divided into the N sample group based on the at least one threshold value, when the at least one threshold value is derived based on the chroma reference samples. In the implementation, the specific luma down-sampled sample may be assigned into the Kth the sample group, when the specific chroma reference sample collocated with the specific luma down-sampled sample is assigned into the Kth sample group.

In at least one implementation, each of the first linear models may be derived by the above-mentioned equation (1). In at least one implementation, the first linear models may include a plurality of first predicted parameters α₁₁, α₁₂, . . . , and α_{1N} and a plurality of first constant parameter β₁₁, β₁₂, . . . , and β_{1N}. In at least one implementation, the intra prediction unit 22221 may derive the first predicted parameters and the first constant parameters based on the reference samples in the reference set, when a plurality of chroma predicted components of the chroma block unit 412 are estimated based on the a plurality of luma reconstructed components of the luma block unit 411. In at least one implementation, each of the first predicted parameters α₁₁, α₁₂, . . . , and α_{1N} and each of the first constant parameters β₁₁, β₁₂, . . . , and β_{1N} are derived based on the reference samples in each of the N sample groups.

In at least one implementation, the intra prediction unit 22221 may estimate the predicted parameters α₁₁, α₁₂, . . . , and α_{1N} and the constant parameters β₁₁, β₁₂, . . . , and β_{1N} based on the chroma reference samples and the luma down-sampled samples in each of the sample groups via a statistical method. In at least one implementation, the statistical method may be a linear regression analysis. In at least one implementation, each of the first predicted parameters α₁₁, α₁₂, . . . , and α_{1N} and each of the first constant parameters β₁₁, β₁₂, . . . , and β_{1N} may be derived by the above-mentioned equation (2). In at least one implementation, the intra prediction unit 22221 may estimate the predicted parameters α₁₁, α₁₂, . . . , and α_{1N} and the constant parameters β₁₁, β₁₂, . . . , and β_{1N} based on a part or all of the chroma reference samples and the luma down-sampled samples in each of the sample groups via other derivation methods. For example, a first one of the predicted parameters α₁₁ and a first one of the constant parameters β₁₁ may be derived based on two of the luma down-sampled samples and two of the chroma reference samples in a first one of the sample groups. In the implementation, the two of the luma down-sampled samples in the first sample group have a fourth maximum sample value and a fourth minimum sample value determined from the luma down-sampled samples in the first sample group. In addition, the two of the chroma reference samples in the first sample groups are collocated with the two of the luma down-sampled samples in the first sample groups. In at least one implementation, the intra prediction unit 22221 may estimate a Rth one of the predicted parameters α_{1R} and a Rth one of the constant parameters β_{1R} based on a part or all of the reference samples in a Rth one of the sample groups via a statistical method or another derivation methods. In at least one implementation, the number R is a positive integer equal to or greater than N.

At block 56, the intra prediction unit 22221 selects the reference set from a plurality of second candidate sets, each including a plurality of second candidate locations selected from the neighboring locations.

In at least one implementation, each of the second candidate sets includes the second candidate locations selected from the plurality of luma neighboring locations 421-428. For example, the second candidate locations in a first one of the second candidate sets may include the first luma neighboring location 421, the third luma neighboring location 423, the fifth luma neighboring location 425, and the seventh luma neighboring location 427 in FIG. 4A. In addition, the second candidate locations in the first one of the second candidate sets may include the first chroma neighboring location 431 and the third chroma neighboring location 433 in FIG. 4B.

In at least one implementation, each of the first candidate sets may be identical to one of the second candidate sets. For example, the first candidate locations in the first one of the first candidate sets may be identical to the second candidate locations in the first one of the first candidate sets. In at least one implementation, the number of the second candidate sets may be equal to or greater than the number of the first candidate sets. In at least one implementation, the second candidate locations in a specific one of the second candidate sets are different from the first candidate locations in each of the first candidate sets, when the number of the second candidate sets is greater than the number of the first candidates. For example, the second candidate locations in the specific second candidate set may include the first chroma neighboring location 431, the second chroma neighboring location 432, the third chroma neighboring location 433, and the fourth chroma neighboring location 434 in FIG. 4B.

In at least one implementation, a Xth one of the second candidate sets includes a first above location having a first height H, when a Xth one of the first candidate sets corresponding the Xth second candidate set includes a second above location having a second height 2H. In at least one implementation, the Xth second candidate set includes a first left location having a first width W, when the Xth first candidate set includes a second left location having a second width 2 W. Thus, each of the first candidate sets may be similar to one of the second candidate sets, since the shapes of the first candidate sets are identical to the shapes of the second candidate sets and the sizes of the first candidate sets are greater than the size of the second candidate sets. For example, the first candidate locations in the first one of the first candidate sets may be similar to the second candidate locations in the first one of the first candidate sets. In the implementation, the number of the reference samples in one of the first candidate sets is twice of the number of the reference samples in one of the second candidate sets. In addition, the number of the reference samples in one of the sample groups determined from one of the first candidate sets is equal to the number of the reference samples in one of the second candidate sets.

In at least one implementation, the number of the second candidate sets may be equal to or greater than the number of the first candidate sets. In at least one implementation, the second candidate locations in a specific one of the second candidate sets are different from the first candidate locations in each of the first candidate sets, when the number of the second candidate sets is greater than the number of the first candidate sets. In at least one implementation, the number X is a positive integer equal to or greater than N.

In at least one implementation, the neighboring locations of the selected second candidate set may be also regarded as the reference locations for the block unit, when the reference set is selected from the second candidate sets. In the implementation, the reference locations may include at least one of the luma neighboring locations and the chroma neighboring locations in the selected second candidate set.

At block 57, the intra prediction unit 22221 determines the reference samples from the selected second candidate locations in the reference set and determines a prediction mode based on the reference set.

In at least one implementation, the neighboring locations may include the neighboring samples. In at least one implementation, the neighboring samples may include the luma neighboring samples located in the luma neighboring locations and the chroma neighboring samples located in the chroma neighboring locations. In at least one implementation, the intra prediction unit 22221 may select the reference samples from the neighboring samples. In the implementation, the reference samples are the neighboring samples located in the reference locations of the reference set. Thus, the reference samples may include the chroma reference samples. In addition, the reference samples may include the luma reference samples. In at least one implementation, the luma reference samples may be the luma neighboring samples located in the luma neighboring locations of the reference set. In at least one implementation, the chroma reference samples may be the chroma neighboring samples located in the chroma neighboring locations of the reference set. In at least one implementation, the luma reference samples may be further down-sampled to determine the luma down-sampled samples in the reference set.

In at least one implementation, the intra prediction unit 22221 may determine that the prediction mode is the CCLM prediction mode and derive a second linear model for the block unit, when the block unit is predicted by one linear model. In one implementation, the block unit is predicted by one linear model, when the reference set is identical to or similar to one of the first candidate sets. In the implementation, the second linear model may be derived by the above-mentioned equation (1) for generating the chroma predicted components in the chroma block unit 412. In at least one implementation, the second linear model may include a second predicted parameter α₂ and a second constant parameter β₂. In at least one implementation, the intra prediction unit 22221 may derive the second predicted parameter α₂ and the second constant parameter β₂ based on the reference samples in the reference set. In at least one implementation, the intra prediction unit 22221 may estimate the second predicted parameter α₂ and the second constant parameter β₂ based on the chroma reference samples and the luma down-sampled samples via the statistical method. In at least one implementation, the second predicted parameter α₂ and the second constant parameter β₂ may be derived by the above-mentioned equation (2). In at least one implementation, the intra prediction unit 22221 may estimate the second predicted parameter α₂ and the second constant parameter β₂ based on a part or all of the chroma reference samples and the luma down-sampled samples via other derivation methods. For example, the second predicted parameter α₂ and the second constant parameter β₂ may be derived based on two of the luma down-sampled samples and two of the chroma reference samples. In the implementation, the two of the luma down-sampled samples have a first maximum sample value and a first minimum sample value determined from the luma down-sampled samples, and the two of the chroma reference samples are collocated with the two of the luma down-sampled samples.

In at least one implementation, the intra prediction unit 22221 may determine that the prediction mode is selected from a plurality of intra candidate modes, when the block unit is not predicted by the second linear model. In one implementation, the block unit is not predicted by the second linear model, when the reference set is different from each of the first candidate sets. For example, the reference set may include the first chroma neighboring location 431, the second chroma neighboring location 432, the third chroma neighboring location 433, and the fourth chroma neighboring location 434 in FIG. 4B. Thus, the intra prediction unit 22221 may further determine the prediction mode based on a chroma mode index, and generate the chroma predicted components in the chroma block unit 412 based on the prediction mode and the reference set. In at least one implementation, each of the intra candidate modes is identical to one of a plurality of luma intra modes. For example, the intra candidate modes may be selected from the luma intra modes having an index equal to 0, 1, 18, 50, and 66 in Versatile Video Coding (VVC) based on a luma prediction mode of the block unit and a chroma mode index. In at least one implementation, the luma prediction mode is used to generate a plurality of luma reconstructed components in the block unit.

At block 58, the intra prediction unit 22221 reconstructs the block unit of the image frame based on the reference samples.

In at least one implementation, the chroma predicted components may be generated based on the luma reconstructed components according to at least one linear model, since the luma reconstructed components are reconstructed prior to generating the chroma predicted components. In at least one implementation, the intra prediction unit 22221 may directly derive the chroma predicted components based on the luma down-sampled components according to the second linear model, when the number of the at least one linear model is equal to one. In at least one implementation, the intra prediction unit 22221 may first compare a specific one of the luma down-sampled components with the at least one threshold value to check which one of the N sample groups the specific luma down-sampled component belongs to, when the chroma predicted components are predicted based on the first linear models. Then, the intra prediction unit 22221 may derive a specific one of the chroma predicted components collocated with the specific luma down-sampled components according to a Qth one of the at least one linear model, when the specific luma down-sampled components belongs to a Qth one of the sample groups. In at least one implementation, the number Q is a positive integer equal to or less than N. In at least one implementation, the intra prediction unit 22221 may directly derive the chroma predicted components based on the chroma reference samples according to one of the intra candidate modes.

In at least one implementation, the chroma block unit 412 may include a plurality of chroma block elements. In the implementation, each of the chroma block elements may be a chroma pixel element. The intra prediction unit 22221 may generate one of the chroma predicted components for each of the block elements. In at least one implementation, the first summer 2224 of the decoder module 222 in the destination device 12 may add the chroma predicted components into a plurality of chroma residual samples determined from the bitstream to reconstruct the chroma block unit of the block unit. In addition, the decoder module 222 may reconstruct all of the other block units in the image frame for reconstructing the image frame and the video.

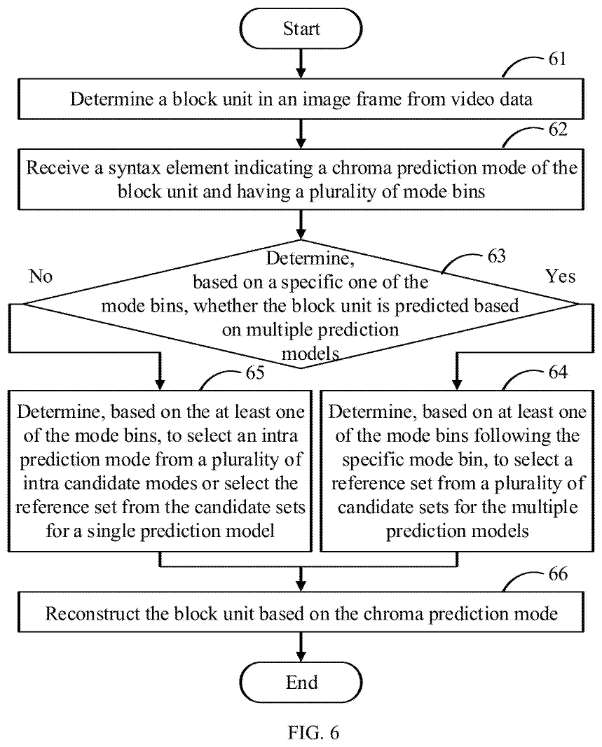

FIG. 6 illustrates a flowchart in accordance with a third example implementation of a mode selection method for intra prediction. The example method is provided by way of example only, as there are a variety of ways to carry out the method. The method described below may be carried out using the configurations illustrated in FIG. 1 and FIG. 2, for example, and various elements of these figures are referenced in explaining the example method. Each block shown in FIG. 6 represents one or more processes, methods, or subroutines, carried out in the example method. Furthermore, the order of blocks is illustrative only and may change. Additional blocks may be added or less blocks may be utilized without departing from this disclosure.

At block 61, the decoder module 222 determines a block unit from an image frame from video data.

In at least one implementation, the video data may be a bitstream. The destination device 12 may receive the bitstream from an encoder, such as the source device 11, via the second interface 123 of the destination device 12. The second interface 123 provides the bitstream to the decoder module 222. The decoder module 222 determines the image frame based on the bitstream, and divides the image frame to determine the block unit according to a plurality of partition indications in the bitstream. For example, the decoder module 222 may divide the image frames to generate a plurality of coding tree units, and further divide one of the coding tree units to determine the block unit according to the partition indications based on any video coding standard.

In at least one implementation, the entropy decoding unit 2221 may decode the bitstream to determine a plurality of prediction indications for the block unit, and then the decoder module 222 may further reconstruct the block unit based on the prediction indications. In at least one implementation, the prediction indications may include a plurality of flags and a plurality of indices.

At block 62, the decoder module 222 receives, from the vide data, a syntax element indicating a chroma prediction mode of the block unit and having a plurality of mode bins.

In at least one implementation, the prediction indications may include the syntax element determined from the bitstream for indicating the chroma prediction mode of the block unit. In the implementation, the syntax element may be intra_chroma_pred_mode. In at least one implementation, a value of the syntax element may be determined by a bin string in the bitstream. In at least one implementation, the bin string may have the mode bins. In at least one implementation, the chroma prediction mode may be selected from a direct mode (DM), a plurality of intra candidate modes, a plurality of cross-component linear model (CCLM) prediction modes each having different candidate sets, and a plurality of multiple model linear model (MMLM) prediction modes each having different candidate sets. In at least one implementation, each of the intra candidate modes is identical to one of a plurality of luma intra modes. For example, the intra candidate modes may be selected from the luma intra modes having an index equal to 0, 1, 18, 50, and 66 in Versatile Video Coding (VVC) based on a luma prediction mode of the block unit. In at least one implementation, the luma prediction mode is used to generate a plurality of luma reconstructed components in the block unit. In at least one implementation, the DM may be identical to the luma prediction mode, when the luma prediction mode is one of the luma intra modes having the index equal to 0, 1, 18, and 50 in VVC. In at least one implementation, each of the candidate sets in the MMLM prediction modes and the CCLM prediction modes indicates a plurality of candidate locations. In at least one implementation, a specific one of the candidate sets is selected for determining a plurality of reference samples to predict the block unit based on one of the MMLM prediction modes and the CCLM prediction modes.

In at least one implementation, the first one of the mode bins may be parsed to determine whether the block unit is predicted by the direct mode (DM). In one implementation, the chroma prediction mode is the DM, when the first of the mode bins is equal to a first bin value. In at least one implementation, the number of the mode bins in the bin string is equal to one, when the chroma prediction mode is determined as the DM by the syntax element. In other words, the bin string does not include the other mode bins, when the chroma prediction mode is the DM. In the implementation, the intra prediction unit 22221 may not predict the block unit based on the third example implementation of the mode selection method, when the chroma prediction mode is the DM. In at least one implementation, the intra prediction unit 22221 may predict the block unit based on the third example implementation of the mode selection method, when the first of the mode bins is equal to a second bin value. In at least one implementation, the first bin value may be equal to zero, and the second bin value may be equal to one. In at least one implementation, the first mode bin may be a DM flag for determining whether the block unit is predicted by the DM.

At block 63, the intra prediction unit 22221 determines, based on a specific one of the mode bins, whether the block unit is predicted by multiple prediction models. When the block unit is predicted by the multiple prediction models, the procedure proceeds to block 64. When the block unit is not predicted by the multiple prediction models, the procedure proceeds to block 65.

In at least one implementation, the chroma prediction mode may be one of the MMLM prediction modes, when the block unit is predicted by the multiple prediction models. In at least one implementation, the chroma prediction mode may be one of the CCLM prediction modes and the intra candidate modes, when the block unit is not predicted by the multiple prediction models.

In at least one implementation, the specific mode bin may be parsed to determine whether the block unit is predicted based on multiple prediction models. In at least one implementation, the intra prediction unit 22221 determines that the block unit is predicted based on the multiple prediction models, when the specific mode bin is equal to a third bin value. Thus, at least one of the mode bins following the specific mode bin may be used to select the chroma prediction mode from the MMLM prediction modes. In at least one implementation, the intra prediction unit 22221 determines that the block unit is not predicted based on the multiple prediction models, when the specific mode bin is equal to a fourth bin value. Thus, the at least one of the mode bins following the specific mode bin may be used to select the chroma prediction mode from the CCLM prediction modes and the intra candidate modes. In at least one implementation, the specific mode bin may be regarded as a model flag. In at least one implementation, the third bin value may be equal to one, and the fourth bin value may be equal to zero.

At block 64, the intra prediction unit 22221 determines, based on the at least one of the mode bins following the specific mode bin, to select a reference set from the candidate sets for the multiple prediction models.

In at least one implementation, the number of the candidate sets is equal to the number of the MMLM prediction modes. For example, the number of the MMLM prediction modes is equal to three, when the number of the candidate sets is equal to three. In at least one implementation, the at least one of the mode bins following the specific modes bin may be used to select one of the candidate sets for the MMLM prediction modes. In the implementation, a bin value of the at least one of the mode bins may be identical to one of a plurality of fifth bin values. In one implementation, the fifth bin values may be 0, 10, and 11.

In at least one implementation, the prediction process unit 2222 determines the block unit from the bitstream, and determines a plurality of neighboring locations neighboring with the block unit. In at least one implementation, the block unit may include a luma block unit and a chroma block unit. In at least one implementation, each of the candidate sets may include the candidate locations selected from a plurality of luma neighboring locations 421-428 in FIG. 4A. For example, the candidate locations in a first one of the candidate sets may include the first luma neighboring location 421, the third luma neighboring location 423, the fifth luma neighboring location 425, and the seventh luma neighboring location 427. In at least one implementation, each of the candidate sets may include the candidate locations selected from a plurality of chroma neighboring locations 431-434 in FIG. 4B. For example, the candidate locations in the first candidate set may include the first chroma neighboring location 431 and the third chroma neighboring location 433. In at least one implementation, each of the candidate sets may correspond to one of the bin values determined from the at least one of the mode bins following the specific mode bin. Thus, the intra prediction unit 22221 may determine, based on the at least one of the mode bins received from the bitstream, to select the reference set from the candidate sets.

At block 65, the intra prediction unit 22221 determines, based on the at least one of the mode bins following the specific mode bin, to select the intra prediction mode from the intra candidate modes or select the reference set from the candidate sets for a single prediction model.

In at least one implementation, the number of the candidate sets is equal to the number of the CCLM prediction modes. For example, the number of the CCLM prediction modes is equal to three, when the number of the candidate sets is equal to three. In at least one implementation, the candidate sets of the CCLM prediction modes may be identical to the candidate sets of the MMLM prediction modes. In at least one implementation, the bin value of the at least one of the mode bins following the specific mode bin may be identical to one of a plurality of sixth bin values and a seventh bin value. In at least one implementation, the chroma prediction mode may be one of the CCLM modes, when the bin value of the at least one of the mode bins following the specific mode bin is identical to one of the sixth bin values. In at least one implementation, the chroma prediction mode may be one of the intra candidate modes, when the bin value of the at least one of the mode bins following the specific mode bin is identical to the seventh bin value. In at least one implementation, the sixth bin values may be 0, 110, and 111, and the seventh bin value may be 10. In at least one implementation, the intra prediction unit 22221 determines that the chroma prediction mode is selected from the intra candidate modes, when the bin value of the at least one of the mode bins following the specific mode bin is identical to the seventh bin value. Thus, there may be a part of the mode bins following the at least one of the mode bins used to determine which one of the intra candidate modes is the chroma prediction mode.

In at least one implementation, a Xth one of the candidate sets for the CCLM prediction modes may include an above location having a first height H, when the Xth candidate set for the MMLM prediction modes includes the above location having a second height 2H. In at least one implementation, the Xth candidate set for the CCLM prediction modes may include a left location having a first width W, when the Xth first candidate set for the MMLM prediction modes includes the left location having a second width 2 W. Thus, each of the CCLM candidate sets may be similar to one of the MMLM candidate sets, since the shapes of the CCLM candidate sets are identical to the shapes of the MMLM candidate sets and the sizes of the MMLM candidate sets are greater than the size of the CCLM candidate sets. For example, the first candidate locations in the first one of the first candidate sets may be similar to the second candidate locations in the first one of the first candidate sets. In at least one implementation, the number X is a positive integer equal to or greater than N.

At block 66, the intra prediction unit 22221 reconstructs the block unit of the image frame based on the chroma prediction mode.

In at least one implementation, a plurality of chroma predicted components may be generated based on the reference set according to at least one linear model, when the intra prediction unit 22221 determines that the block unit is predicted by one of the MMLM prediction modes and the CCLM prediction modes. In at least one implementation, the intra prediction unit 22221 may determine the reference samples located in the reference set. In at least one implementation, the intra prediction unit 22221 may derive a plurality of first linear models based on the reference samples in a plurality of samples groups each corresponding to one of the first linear models, when the block unit is predicted based on one of the MMLM prediction modes. In at least one implementation, the intra prediction unit 22221 may derive a second linear model based on the reference samples, when the block unit is predicted based on one of the CCLM prediction modes.

In at least one implementation, the chroma predicted components may be generated according to the intra prediction mode, when the intra prediction unit 22221 determines that the block unit is predicted by one of the intra candidate modes.

In at least one implementation, the chroma block unit 412 may include a plurality of chroma block elements. In the implementation, each of the chroma block elements may be a chroma pixel element. The intra prediction unit 22221 may generate one of the chroma predicted components for each of the block elements. In at least one implementation, the first summer 2224 of the decoder module 222 in the destination device 12 may add the chroma predicted components into a plurality of chroma residual samples determined from the bitstream to reconstruct the chroma block unit of the block unit. In addition, the decoder module 222 may reconstruct all of the other block units in the image frame for reconstructing the image frame and the video.

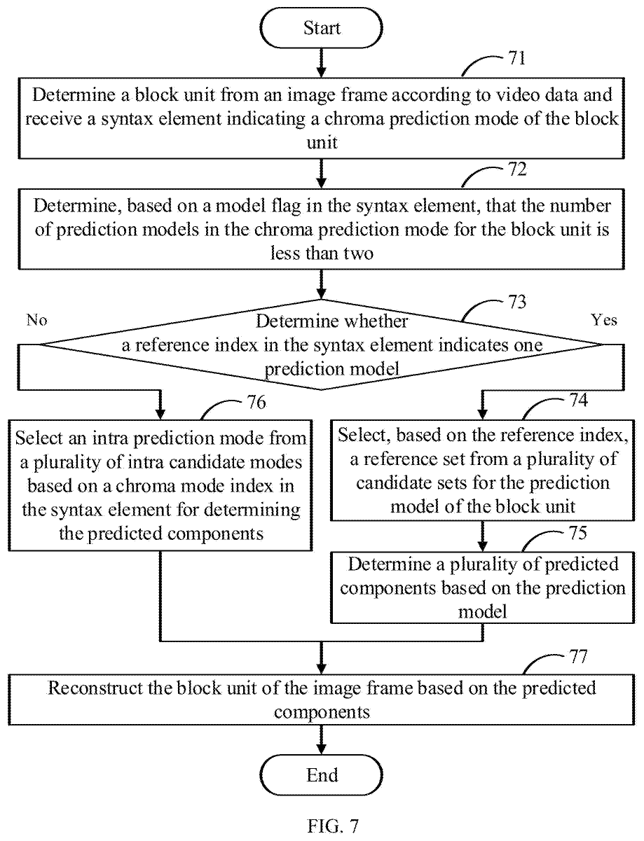

FIG. 7 illustrates a flowchart in accordance with a fourth example implementation of the mode selection method for intra prediction. The example method is provided by way of example only, as there are a variety of ways to carry out the method. The method described below may be carried out using the configurations illustrated in FIG. 1 and FIG. 2, for example, and various elements of these figures are referenced in explaining the example method. Each block shown in FIG. 7 represents one or more processes, methods, or subroutines, carried out in the example method. Furthermore, the order of blocks is illustrative only and may change. Additional blocks may be added or less blocks may be utilized without departing from this disclosure.

At block 71, the decoder module 222 determines a block unit from an image frame according to video data, and receive a syntax element indicating a chroma prediction mode of the block unit.

In at least one implementation, the video data may be a bitstream. The destination device 12 may receive the bitstream from an encoder, such as the source device 11, via the second interface 123 of the destination device 12. The second interface 123 provides the bitstream to the decoder module 222. The decoder module 222 determines the image frame based on the bitstream, and divides the image frame to determine the block unit according to a plurality of partition indications in the bitstream. For example, the decoder module 222 may divide the image frames to generate a plurality of coding tree units, and further divide one of the coding tree units to determine the block unit according to the partition indications based on any video coding standard.

In at least one implementation, the entropy decoding unit 2221 may decode the bitstream to determine a plurality of prediction indications for the block unit, and then the decoder module 222 may further reconstruct the block unit based on the prediction indications. In at least one implementation, the prediction indications may include a plurality of flags and a plurality of indices.

In at least one implementation, the prediction indications may include the syntax element determined from the bitstream for indicating the chroma prediction mode of the block unit. In the implementation, the syntax element may be intra_chroma_pred_mode. In at least one implementation, a value of the syntax element may be determined by a bin string in the bitstream. In at least one implementation, the bin string may have a plurality of mode bins. In at least one implementation, the chroma prediction mode may be selected from a direct mode (DM), a plurality of intra candidate modes, a plurality of cross-component linear model (CCLM) prediction modes each having different candidate sets, and a plurality of multiple model linear model (MMLM) prediction modes each having different candidate sets. In at least one implementation, each of the intra candidate modes is identical to one of a plurality of luma intra modes. For example, the intra candidate modes may be selected from the luma intra modes having an index equal to 0, 1, 18, 50, and 66 in Versatile Video Coding (VVC) based on a luma prediction mode of the block unit. In at least one implementation, the luma prediction mode is used to generate a plurality of luma reconstructed components in the block unit. In at least one implementation, the DM may be identical to the luma prediction mode, when the luma prediction mode is one of the luma intra modes having the index equal to 0, 1, 18, and 50 in VVC. In at least one implementation, each of the candidate sets in the MMLM prediction modes and the CCLM prediction modes indicates a plurality of candidate locations. In at least one implementation, a specific one of the candidate sets is selected for determining a plurality of reference samples to predict the block unit based on one of the MMLM prediction modes and the CCLM prediction modes.

In at least one implementation, the first one of the mode bins may be parsed to determine whether the block unit is predicted by the DM. In one implementation, the chroma prediction mode is the DM, when the first of the mode bins is equal to a first bin value. In the implementation, the number of the mode bins in the bin string is equal to one. In other words, the bin string does not include the other mode bins, when the chroma prediction mode is the DM. In the implementation, the intra prediction unit 22221 may not predict the block unit based on the fourth example implementation of the mode selection method, when the chroma prediction mode is the DM. In at least one implementation, the intra prediction unit 22221 may predict the block unit based on the fourth example implementation of the mode selection method, when the first of the mode bins is equal to a second bin value. In at least one implementation, the first bin value may be equal to zero, and the second bin value may be equal to one. In at least one implementation, the first mode bin may be a DM flag for determining whether the block unit is predicted by the DM.

At block 72, the intra prediction unit 22221 determines, based on a model flag in the syntax element, that the number of prediction models in the chroma prediction mode for the block is less than two.

In at least one implementation, the model flag in the syntax element may be parsed for determining the number of the prediction models in the chroma prediction mode. In at least one implementation, the intra prediction unit 22221 determines that the number of the prediction models in the chroma prediction mode is greater than one, when the model flag is equal to a first flag value. In at least one implementation, the intra prediction unit 22221 determines that the number of prediction models in the chroma prediction mode for the block is less than two, when the model flag is equal to a second flag value. In at least one implementation, the model flag is just behind the DM flag, when the chroma prediction mode is different from the DM. In at least one implementation, the first flag value may be equal to one, and a second flag value may be equal to zero.

In at least one implementation, the block unit is predicted by the MMLM prediction modes, when the number of prediction models in the chroma prediction mode for the block is greater than or equal to two. In the implementation, the intra prediction unit 22221 may not predict the block unit based on the fourth example implementation of the mode selection method, when the block unit is predicted by the MMLM prediction modes. In at least one implementation, the block unit is predicted by one of the CCLM prediction modes and the intra candidate modes, when the number of prediction models in the chroma prediction mode for the block is less than two. In the implementation, the intra prediction unit 22221 may predict the block unit based on the fourth example implementation of the mode selection method, when the block unit is predicted by one of the CCLM prediction modes and the intra candidate modes.

At block 73, the intra prediction unit 22221 determines whether a reference index in the syntax element indicates one prediction model. When the block unit is predicted by the one prediction model, the procedure proceeds to block 74. When the block unit is not predicted by the prediction model, the procedure proceeds to block 76.

In at least one implementation, the reference index in the syntax element may be parsed for determining whether the block unit is predicted by the prediction model. In at least one implementation, the reference index in the syntax element may be further used to determining how to predict the block unit by the prediction model, when the block unit is predicted by the prediction model. For example, the reference index may be identical to one of a plurality of first index values and a second index value. In at least one implementation, the intra prediction unit 22221 may determine that the block unit is not predicted by the prediction model, when the reference index is identical to the second index value. Thus, the procedure proceeds to block 76 for determining how to predict the block unit. In at least one implementation, the intra prediction unit 22221 may determine that the block unit is predicted by the prediction model, when the reference index is identical to one of the first index values. Thus, the procedure proceeds to block 74 for determining how to predict the block unit based on the prediction model according to the reference index. In at least one implementation, the first index values may be 0, 110, and 111, and the second index value may be 10.

At block 74, the intra prediction unit 22221 selects, based on the reference index, a reference set from the candidate sets for the prediction model of the block unit.

In at least one implementation, the number of the candidate sets is equal to the number of the CCLM prediction modes. In at least one implementation, each of the first index values for the reference index corresponds to one of the candidate sets in the CCLM prediction modes. For example, the number of the CCLM prediction modes is equal to three and the number of the first index values is equal to three, when the number of the candidate sets is equal to three. For example, the first index values may be 0, 100, and 111.

In at least one implementation, the prediction process unit 2222 determines the block unit from the bitstream, and determines a plurality of neighboring locations neighboring with the block unit. In at least one implementation, the block unit may include a luma block unit and a chroma block unit. In at least one implementation, each of the candidate sets includes a plurality of candidate locations selected from a plurality of luma neighboring locations 421-428 in FIG. 4A. For example, the candidate locations in a first one of the candidate sets may include the first luma neighboring location 421, the third luma neighboring location 423, the fifth luma neighboring location 425, and the seventh luma neighboring location 427. In at least one implementation, each of the candidate sets includes the candidate locations selected from a plurality of chroma neighboring locations 431-434 in FIG. 4B. For example, the candidate locations in the first candidate set may include the first chroma neighboring location 431 and the third chroma neighboring location 433. In at least one implementation, the intra prediction unit 22221 may determine, based on a specific one of the first index values received from the bitstream, to select the reference set from the candidate sets.

At block 75, the intra prediction unit 22221 determines a plurality of predicted components based on the prediction model, for example, according to the reference set.

In at least one implementation, the neighboring locations may include a plurality of neighboring samples. In the implementation, the reference samples are the neighboring samples located in the reference set. In at least one implementation, the reference samples may include a plurality of chroma reference samples and a plurality of luma reference samples. In at least one implementation, the luma reference samples may be further down-sampled to determine the luma down-sampled samples in the reference set.

In at least one implementation, the intra prediction unit 22221 may derive a linear model based on the reference samples in the reference set. In at least one implementation, the intra prediction unit 22221 may derive the linear model based on the chroma reference samples and the luma down-sampled samples via a statistical method. In at least one implementation, the intra prediction unit 22221 may derive the linear model based on a part or all of the chroma reference samples and the luma down-sampled samples via other derivation methods.

In at least one implementation, the predicted components may be generated based on the luma reconstructed components of the block unit according to the linear model, since the luma reconstructed components are reconstructed prior to generating the chroma predicted components. In at least one implementation, the intra prediction unit 22221 may derive the predicted components based on the luma down-sampled components according to the linear model.

At block 76, the intra prediction unit 22221 select an intra prediction mode from a plurality of intra candidate modes based on a chroma mode index in the syntax element for determining the predicted components.

In at least one implementation, the chroma mode index in the syntax element may be parsed for determining which one of the intra candidate modes is the intra prediction mode. In at least one implementation, the chroma mode index may be identical to one of a plurality of third index values. In the implementation, the third index values may be 00, 01, 10, and 11, when the number of the third index values is equal to four.

In at least one implementation, the intra prediction unit 22221 may determine that the prediction mode is selected from the intra candidate modes, when the reference index is equal to the second index value. Thus, the intra prediction unit 22221 may determine the prediction mode based on the chroma mode index and a luma mode index of the block unit, and generate the predicted components in the chroma block unit 412 based on the intra prediction mode. In at least one implementation, the intra candidate modes may include a DC mode, a Planar, a plurality of directional modes. For example, the directional modes may include a horizontal mode, a vertical mode, and an inclined mode from the bottom-left towards the top-right. In at least one implementation, the intra prediction unit 22221 may determine the predicted components based on the intra prediction mode, when the intra prediction mode is determined from the intra candidate modes based on the chroma mode index.

At block 77, the intra prediction unit 22221 reconstructs the block unit of the image frame based on the predicted components.

In at least one implementation, the chroma block unit 412 may include a plurality of chroma block elements. In the implementation, each of the chroma block elements may be a chroma pixel element. The intra prediction unit 22221 may generate one of the predicted components for each of the block elements. In at least one implementation, the first summer 2224 of the decoder module 222 in the destination device 12 may add the predicted components into a plurality of chroma residual samples determined from the bitstream to reconstruct the chroma block unit of the block unit. In addition, the decoder module 222 may reconstruct all of the other block units in the image frame for reconstructing the image frame and the video.

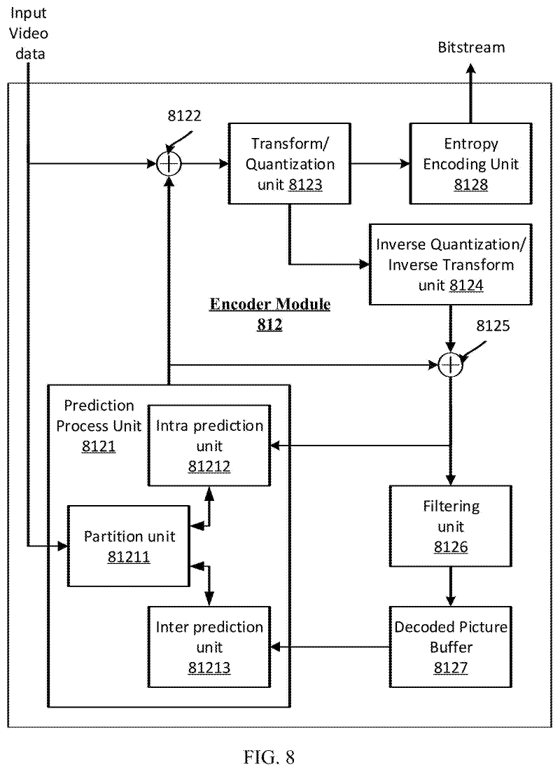

FIG. 8 is a block diagram of an encoder module 812 representing an example implementation of the encoder module 812 of the source device 11 in the system of FIG. 1. In at least one implementation, the encoder module 812 includes a prediction processor (e.g., a prediction process unit 8121), at least one summer (e.g., a first summer 8122 and a second summer 8125), a quantization/inverse transform processor (e.g., a transform/quantization unit 8123), an inverse quantization/inverse transform processor (e.g., an inverse quantization/inverse transform unit 8124), a filter (e.g., a filtering unit 8126), a decoded picture buffer (e.g., a decoded picture buffer 8127), and an entropy encoder (e.g., an entropy encoding unit 8128). In at least one implementation, the prediction process unit 8121 of the encoder module 812 further includes a partition processor (e.g., a partition unit 81211), an intra prediction unit 81212, and an inter prediction unit 81213. In at least one implementation, the encoder module 812 receives the source video, and encodes the source video to output a bitstream.

In at least one implementation, the encoder module 812 may receive a source video including a plurality of image frames, and then divide the image frames according to a coding structure. In at least one implementation, each of the image frames may be divided into at least one image block. The at least one image block may include a luminance block having a plurality of luminance samples, and at least one chrominance block having a plurality of chrominance samples. The luminance block and the at least one chrominance block may be further divided to generate macroblocks, coding tree units (CTUs), coding blocks (CBs), sub-divisions thereof, and/or another equivalent coding unit. In at least one implementation, the encoder module 812 may perform additional sub-divisions of the source video. It should be noted that the disclosure described herein are generally applicable to video coding, regardless of how the source video is partitioned prior to and/or during encoding.

In at least one implementation, during the encoding process, the prediction process unit 8121 receives a current image block of a specific one of the image frames. The current image block may be one of the luminance block and the at least one of the chrominance block in the specific image frame. The partition unit 81211 divides the current image block into multiple block units. The intra prediction unit 81212 may perform intra-predictive coding of a current block unit relative to one or more neighboring blocks in the same frame as the current block unit to provide spatial prediction. The inter prediction unit 81213 may perform inter-predictive coding of the current block unit relative to one or more blocks in one or more reference image block to provide temporal prediction.

In at least one implementation, the prediction process unit 8121 may select one of the coding results generated by the intra prediction unit 81212 and the inter prediction unit 81213 based on a mode selection method, such as a cost function. In at least one implementation, the mode selection method may be a rate-distortion optimization (RDO) process. The prediction process unit 8121 determines the selected coding result, and provides a predicted block corresponding to the selected coding result to the first summer 8122 for generating a residual block and to the second summer 8125 for reconstructing the encoded block unit. In at least one implementation, the prediction process unit 8121 may further provide syntax elements, such as motion vectors, intra-mode indicators, partition information, and other syntax information, to the entropy encoding unit 8128.

In at least one implementation, the intra prediction unit 81212 may intra-predict the current block unit. In at least one implementation, the intra prediction unit 81212 may determine an intra-prediction mode directing toward reconstructed sample neighboring to the current block unit to encode the current block unit. In at least one implementation, the intra prediction unit 81212 may encode the current block unit using various intra-prediction modes, and the intra prediction unit 81212 or the prediction process unit 8121 may select an appropriate intra-prediction mode from the tested modes. In at least one implementation, the intra prediction unit 81212 may encode the current block unit using a cross component prediction mode to predict one of the two chroma components of the current block unit based on the luma components of the current block unit. In addition, the intra prediction unit 81212 may predict a first one of the two chroma components of the current block unit based on the other of the two chroma components of the current block unit.

In at least one implementation, the inter prediction unit 81213 may inter-predict the current block unit as an alternative to the intra-prediction performed by the intra prediction unit 81212, as described above. The inter prediction unit 81213 may perform a motion estimation to estimate a motion of the current block unit for generating a motion vector. The motion vector may indicate a displacement of the current block unit within the current image block relative to a reference block unit within a reference image block. In at least one implementation, the inter prediction unit 81213 receives at least one reference image block stored in the decoded picture buffer 8127 and estimates the motion based on the received reference image blocks to generate the motion vector.

In at least one implementation, the first summer 8122 generates the residual block by subtracting the prediction block determined by the prediction process unit 8121 from the original current block unit. The first summer 8122 represents the component or components that perform this subtraction operation.

In at least one implementation, the transform/quantization unit 8123 applies a transform to the residual block to generate a residual transform coefficient, and then quantizes the residual transform coefficients to further reduce bit rate. In at least one implementation, the transform may be DCT, DST, AMT, MDNSST, HyGT, signal dependent transform, KLT, wavelet transform, integer transform, sub-band transform or a conceptually similar transform. In at least one implementation, the transform may convert the residual information from a pixel value domain to a transform domain, such as a frequency domain. In at least one implementation, the degree of quantization may be modified by adjusting a quantization parameter. In at least one implementation, the transform/quantization unit 8123 may perform a scan of the matrix including the quantized transform coefficients. Alternatively, the entropy encoding unit 8128 may perform the scan.

In at least one implementation, the entropy encoding unit 8128 may receive a plurality of syntax elements including quantization parameter, transform data, motion vectors, intra modes, partition information, and other syntax information, from the prediction process unit 8121, and the transform/quantization unit 8123, and encode encodes the syntax elements into the bitstream. In at least one implementation, the entropy encoding unit 8128 entropy encodes the quantized transform coefficients. In at least one implementation, the entropy encoding unit 8128 may perform CAVLC, CABAC, SBAC, PIPE coding or another entropy coding technique to generate an encoded bitstream. In at least one implementation, the encoded bitstream may be transmitted to another device (e.g., the destination device 12) or archived for later transmission or retrieval.

In at least one implementation, the inverse quantization/inverse transform unit 8124 may apply inverse quantization and inverse transformation to reconstruct the residual block in the pixel domain for later use as a reference block. In at least one implementation, the second summer 8125 adds the reconstructed residual block to the prediction block provided from the prediction process unit 8121 to produce a reconstructed block for storage in the decoded picture buffer 8127.

In at least one implementation, the filtering unit 8126 may include a deblocking filter, a SAO filter, a bilateral filter, and/or an ALF to remove blockiness artifacts from the reconstructed block. Additional filters (in loop or post loop) may also be used in addition to the deblocking filter, the SAO filter, the bilateral filter and the ALF. Such filters are not shown for brevity, but if desired, may filter the output of the second summer 8125.

In at least one implementation, the decoded picture buffer 8127 may be a reference picture memory that stores the reference block for use in encoding video by the encoder module 812, e.g., in intra- or inter-coding modes. The decoded picture buffer 8127 may be formed by any of a variety of memory devices, such as DRAM, including SDRAM, MRAM, RRAM), or other types of memory devices. In at least one implementation, the decoded picture buffer 8127 may be on-chip with other components of the encoder module 812, or off-chip relative to those components.

In at least one implementation, the encoder module 812 may perform the linear model prediction method based on different reference sets as shown in FIG. 3. The method in FIG. 3 may be carried out using the configurations illustrated in FIG. 1 and FIG. 10, for example, and various elements of these figures are referenced in explaining the example method. Furthermore, the order of blocks in FIG. 3 is illustrative only and may change. Additional blocks may be added or less blocks may be utilized without departing from this disclosure.

At block 31, the encoder module 812 determines a block unit from an image frame according to video data.

In at least one implementation, the video data may be a video. The source device 11 may receive the video by the source module 111. The encoder module 812 determines the image frame from the video, and divides the image frame to determine the block unit.

In at least one implementation, the prediction process unit 8121 of the source device 11 determines the block unit from the video via the partition unit 81211, and then the encoder module 812 provides a plurality of partition indications into a bitstream based on a partition result of the partition unit 81211.

At block 32, the intra prediction unit 81212 selects a prediction mode of the block unit from a plurality of linear modes, each including at least one model prediction.

In at least one implementation, the prediction modes may include a cross-component linear model (CCLM) prediction mode and a multiple models linear model (MMLM) prediction mode. In at least one implementation, the intra prediction unit 81212 may use a linear model to predict the block unit, when the prediction mode is the CCLM prediction mode. In at least one implementation, the intra prediction unit 81212 may use more than one linear model to predict the block unit, when the prediction mode is the MMLM prediction mode.

At block 33, the intra prediction unit 81212 selects a reference set of the block unit from a plurality of candidate sets, each including a plurality of candidate locations selected from a plurality of neighboring locations neighboring to the block unit.

In at least one implementation, the intra prediction unit 81212 determines the block unit from the video, and determines the neighboring locations neighboring to the block unit. In at least one implementation, the neighboring locations in the selected candidate set may be a plurality of reference locations for the block unit, when the reference set is selected from the candidate sets. In at least one implementation, the block unit may include a luma block unit and a chroma block unit. In the implementation, the reference locations may include a plurality of luma neighboring locations and a plurality of chroma neighboring locations of the selected candidate set.

At block 34, the intra prediction unit 81212 determines a plurality of reference samples from the selected candidate locations in the reference set.

In at least one implementation, the neighboring locations may include a plurality of neighboring samples. In the implementation, the neighboring samples may include a plurality of luma neighboring samples located in the luma neighboring locations and a plurality of chroma neighboring samples located in the chroma neighboring locations. In the implementation, the reference samples are the neighboring samples located in the reference locations of the reference set. Thus, the reference samples may include a plurality of luma reference samples and a plurality of chroma reference samples. In at least one implementation, the intra prediction unit 81212 may further down-sample the luma reference samples to determine a plurality of luma down-sampled samples in the reference set.

At block 35, the intra prediction unit 81212 derives a linear model, based on the reference samples, for each of the at least one model prediction in the prediction mode.

In at least one implementation, each of the at least one linear model may be derived by the above-mentioned equation (1). In at least one implementation, the at least one linear model may include at least one predicted parameter and at least one constant parameter. In at least one implementation, each of the at least one predicted parameter and the at least one constant parameter may be derived by the above-mentioned equation (2). In at least one implementation, the intra prediction unit 81212 may estimate the at least one predicted parameter and the at least one constant parameter based on a part or all of the chroma reference samples and the luma down-sampled samples in at least one sample group via other derivation methods.

At block 36, the intra prediction unit 81212 reconstructs the block unit of the image frame based on the derived at least one linear model.

In at least one implementation, the chroma predicted components may be generated based on the luma reconstructed components according to the at least one linear model, since the luma reconstructed components are reconstructed prior to generating the chroma predicted components.

In at least one implementation, the block unit may include a plurality of block elements. In the implementation, each of the block elements may be a pixel element. In at least one implementation, the intra prediction unit 81212 may determine the chroma predicted components for each of the block elements. In the implementation, the encoder module 812 predicts the block unit to generate a plurality of residual samples based on the chroma predicted components, and provide the bitstream including a plurality of coefficients corresponding to the residual samples. In addition, the encoder module 812 may return the residual samples based on the coefficients, and add the returned residual samples into the chroma predicted components to generate a plurality of chroma reconstructed components.

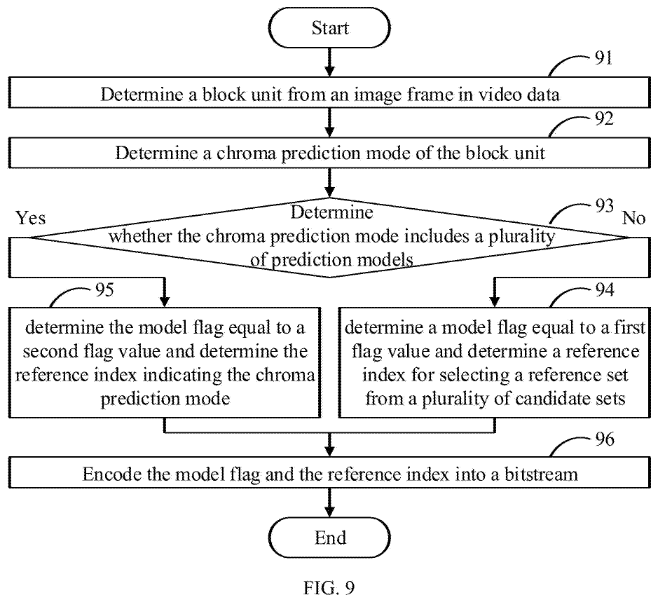

FIG. 9 illustrates a flowchart in accordance with an example implementation of a mode signaling method for chroma intra prediction. The example method is provided by way of example only, as there are a variety of ways to carry out the method. The method described below may be carried out using the configurations illustrated in FIG. 1 and FIG. 8, for example, and various elements of these figures are referenced in explaining the example method. Each block shown in FIG. 9 represents one or more processes, methods, or subroutines, carried out in the example method. Furthermore, the order of blocks is illustrative only and may change. Additional blocks may be added or less blocks may be utilized without departing from this disclosure.

At block 91, the encoder module 812 determines a block unit in an image frame in video data.

In at least one implementation, the video data may be a video. The source device 11 may receive the video by the source module 111. The encoder module 812 determines the image frame from the video, and divides the image frame to determine the block unit. In at least one implementation, the prediction process unit 8121 of the source device 11 determines the block unit from the video via the partition unit 81211, and the encoder module 812 provides a plurality of partition indications into a bitstream based on a partition result of the partition unit 81211.

At block 92, the intra prediction unit 81212 determines a chroma prediction mode of the block unit.

In at least one implementation, the chroma prediction mode may be selected from a direct mode (DM), a plurality of intra candidate modes, a plurality of cross-component linear model (CCLM) prediction modes each having different candidate sets, and a plurality of multiple model linear model (MMLM) prediction modes each having different candidate sets. In at least one implementation, each of the intra candidate modes is identical to one of a plurality of luma intra modes. For example, the intra candidate modes may be selected from the luma intra modes having an index equal to 0, 1, 18, 50, and 66 in Versatile Video Coding (VVC) based on a luma prediction mode of the block unit. In at least one implementation, the luma prediction mode is used to generate a plurality of luma reconstructed components in the block unit. In at least one implementation, each of the candidate sets in the MMLM prediction modes and the CCLM prediction modes indicates a plurality of candidate locations. In at least one implementation, a specific one of the candidate sets is selected for determining a plurality of reference samples to predict the block unit based on one of the MMLM prediction modes and the CCLM prediction modes.

At block 93, the intra prediction unit 81212 determines whether the chroma prediction mode includes a plurality of prediction models. In at least one implementation, the procedure proceeds to block 94, when the chroma prediction mode includes the prediction models. In at least one implementation, the procedure proceeds to block 95, when the number of the prediction models in the chroma prediction mode is one or less.

In at least one implementation, the block unit is predicted by one of the MMLM prediction modes, when the block unit is predicted by the prediction models. In at least one implementation, the block unit is predicted by one of the CCLM prediction modes and the intra candidate modes, when the number of the prediction models in the chroma prediction mode is less than two.

At block 94, the encoder module 812 determines a model flag equal to a first flag value and determine a reference index for selecting a reference set from a plurality of candidate sets.

In at least one implementation, the encoder module 812 may determine the model flag be equal to the first flag value, when the intra prediction unit 81212 determines the chroma prediction mode includes the prediction models. In at least one implementation, the first flag value is equal to one. In at least one implementation, the reference index may be selected from a plurality of first index values. In at least one implementation, each of the candidate sets corresponds to one of the first index values. Thus, the encoder module 812 may determine that the reference index is equal to a specific one of the first index values corresponding to a specific one of the candidate sets, when the intra prediction unit 81212 determines that the chroma prediction mode is a specific one of the MMLM prediction modes including the specific candidate set. In at least one implementation, the first index values may be 0, 10, and 11, when the number of the first index values is equal to three.

At block 95, the encoder module 812 determines the model flag equal to a second flag value and determines the reference index indicating the chroma prediction mode.

In at least one implementation, the encoder module 812 may determine the model flag be equal to the second flag value, when the intra prediction unit 81212 determines the number of the prediction models in the chroma prediction mode is less than two. In at least one implementation, the second flag value is equal to zero. In at least one implementation, the reference index may be selected from a plurality of second index values and a third index value. In at least one implementation, the reference index may be selected from the second index values for selecting the reference set from the candidate sets, when the chroma prediction mode is one of the CCLM prediction modes. In at least one implementation, the reference index may be identical to the third index value, when the chroma prediction mode is one of the intra candidate modes. In at least one implementation, each of the candidate sets corresponds to one of the second index values. In at least one implementation, the number of the second index values is equal to the number of the candidate sets. Thus, the encoder module 812 may determine that the reference index is equal to a specific one of the second index values corresponding to a specific one of the candidate sets, when the intra prediction unit 81212 determines that the chroma prediction mode is a specific one of the CCLM prediction modes including the specific candidate set. In addition, the encoder module 812 may determine that the reference index is equal to the third index value, when the intra prediction unit 81212 determines that the chroma prediction mode is one of the intra candidate modes. In at least one implementation, the encoder module 812 may further determine a mode index for determining which one of the intra candidate modes is the chroma prediction mode. In at least one implementation, the second index values may be 0, 110, and 111, and the third index value may be 10.

At block 96, the encoder module 812 encodes the model flag and the reference index into a bitstream.

In at least one implementation, the encoder module 812 generates the bitstream including the model flag and the reference index of the block unit for providing the bitstream to the destination device 12 in FIG. 1. In at least one implementation, the bitstream may include the mode index of the block unit, when the intra prediction units 812 selects one of the intra candidate modes as the chroma prediction mode.

From the above description, it is manifest that various techniques may be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method of decoding a bitstream by an electronic device, the method comprising:
determining a block unit from an image frame according to the bitstream;
selecting a prediction mode of the block unit from a plurality of linear modes, each including at least one model prediction;
selecting a reference set of the block unit from a plurality of candidate sets, each including a plurality of candidate locations selected from a plurality of neighboring locations neighboring the block unit;
determining a plurality of reference samples from the plurality of selected candidate locations in the reference set;
deriving a linear model, based on the plurality of reference samples, for each of the at least one model prediction in the prediction mode; and
reconstructing the block unit based on the at least one linear model.

2. The method according to claim 1, wherein a plurality of neighboring samples is located in the plurality of neighboring locations, and the plurality of reference samples is the plurality of neighboring samples in the plurality of selected candidate locations of the reference set.

3. The method according to claim 1, wherein a first one of the plurality of candidate sets includes the plurality of neighboring locations located above the block unit and located to a left side of the block unit, a second one of the plurality of candidate sets includes the plurality of neighboring locations located to the left side of the block unit and located to a left-below side of the block unit, and a third one of the plurality of candidate sets includes the plurality of neighboring locations located above the block unit and located to a top-right side of the block unit.

4. The method according to claim 1, wherein the plurality of reference samples is separated into a plurality of sample groups based on at least one threshold value derived from a maximum sample value and a minimum sample value of the plurality of reference samples, when the number of the at least one model prediction is greater than one.

5. The method according to claim 4, wherein the at least one sample value is equal to an average value of the maximum sample value and the minimum sample value, when the number of the at least one model prediction in the prediction mode is equal to two.

6. The method according to claim 4, wherein each of the plurality of reference samples includes a luma sample value and a chroma sample value, and each of the plurality of luma sample values is compared with the at least one threshold value for separating the plurality of reference samples into the plurality of sample groups.

7. The method according to claim 1, wherein the prediction mode is selected from the plurality of linear modes based on a model flag, and the reference set is selected from the plurality of candidate sets based on a reference index.

8. An electronic device for decoding a bitstream, the electronic device comprising:
at least one processor; and
a storage device coupled to the at least one processor and storing a plurality of instructions which, when executed by the at least one processor, causes the at least one processor to:
determine a block unit from an image frame according to the bitstream;
select a prediction mode of the block unit from a plurality of linear modes, each including at least one model prediction;
select a reference set of the block unit from a plurality of candidate sets, each including a plurality of candidate locations selected from a plurality of neighboring locations neighboring to the block unit;
determine a plurality of reference samples from the plurality of selected candidate locations in the reference set;
derive a linear model, based on the plurality of reference samples, for each of the at least one model prediction in the prediction mode; and
reconstruct the block unit based on the at least one linear model.

9. The electronic device according to claim 8, wherein a plurality of neighboring samples is located in the plurality of neighboring locations, and the plurality of reference samples is the plurality of neighboring samples in the plurality of selected candidate locations of the reference set.

10. The electronic device according to claim 8, wherein a first one of the plurality of candidate sets includes the plurality of neighboring locations located above the block unit and located to a left side of the block unit, a second one of the plurality of candidate sets includes the plurality of neighboring locations located to the left side of the block unit and located to a left-below side of the block unit, and a third one of the plurality of candidate sets includes the plurality of neighboring locations located above the block unit and located to a top-right side of the block unit.

11. The electronic device according to claim 8, wherein the plurality of reference samples is separated into a plurality of sample groups based on at least one threshold value derived from a maximum sample value and a minimum sample value of the plurality of reference samples, when the number of the at least one model prediction is greater than one.

12. The electronic device according to claim 11, wherein the at least one sample value is equal to an average value of the maximum sample value and the minimum sample value, when the number of the at least one model prediction in the prediction mode is equal to two.

13. The electronic device according to claim 11, wherein each of the plurality of reference sample includes a luma sample value and a chroma sample value, and each of the plurality of luma sample values is compared with the at least one threshold value for separating the plurality of reference samples into the sample groups.

14. The method according to claim 8, wherein the prediction mode is selected from the plurality of linear modes based on a model flag, and the reference set is selected from the plurality of candidate sets based on a reference index.

15. A method of decoding a bitstream by an electronic device, the method comprising:
determining a block unit from an image frame according to the bitstream;
determining, based on a model flag, whether the block unit is predicted by a plurality of prediction models;
selecting, based on a first reference index, a reference set of the block unit from a plurality of first candidate sets, each including a plurality of first candidate locations selected from a plurality of neighboring locations neighboring to the block unit, when the block unit is predicted by the plurality of prediction models;
determining a plurality of reference samples from the plurality of selected first candidate locations in the reference set;
deriving a plurality of first linear models, based on the plurality of reference samples for the plurality of prediction models; and
reconstructing the block unit based on the plurality of first linear models.

16. The method according to claim 15, further comprising:
selecting, based on a second reference index, the reference set of the block unit from a plurality of second candidate sets, each including a plurality of second candidate locations selected from the plurality of neighboring locations neighboring to the block unit, when the model flag indicates that the number of the plurality of prediction models is less than two;
determining the plurality of reference samples from the plurality of selected second candidate locations in the reference set; and
reconstructing the block unit based on the plurality of reference samples.

17. The method according to claim 16, wherein each of the first candidate sets is included in the second candidate sets.

18. The method according to claim 16, further comprising:
deriving a second linear model, based on the plurality of reference samples, when the reference sets is identical to one of the first candidate sets; and
reconstructing the block unit based on the second linear model.

19. The method according to claim 16, further comprising:
selecting an intra prediction mode from a plurality of intra candidate modes based on a chroma mode index and an intra luma mode of the block unit, when the reference sets is different from each of the first candidate sets; and
reconstructing the block unit through the plurality of reference samples based on the intra prediction mode.

20. The method according to claim 15, wherein the plurality of reference samples is separated into a plurality of sample groups based on at least one threshold value derived from a maximum sample value and a minimum sample value of the plurality of reference samples, when the block unit is predicted by the plurality of prediction models.
